(19) United States
(12) Patent Application Publication
(10) Pub. No.: US 2022/0304350 A1
(43) Pub. Date: Sep. 29, 2022

(54) Systems and methods for imparting flavoring and/or lubrication to a surface

(71) Applicant: Spellbound Development Group, Inc., Irvine, CA (US)

(72) Inventors: Earl Joseph Votolato, Newport Beach, CA (US); Carlos David Reyes, Rancho Santa Margarita, CA (US); Amanda Jeanne Brooks, Santa Ana, CA (US); Ryan Michael Burkes, Cary, NC (US)

(21) Appl. No.: 17/342,360

(22) Filed: Jun. 8, 2021

Related U.S. Application Data
(63) Continuation-in-part of application No. 17/214,109, filed on Mar. 26, 2021.

(51) Int. Cl. A23L 27/00

(52) U.S. Cl. CPC A23L 27/70; A23L 27/88; A23V 2002/00

(57) ABSTRACT

Edible sheets for use in the preparation of food products and/or direct consumption by consumers are disclosed. The edible sheets include at least one flexible or semi-rigid membrane or layer of a base material having particles of one or more functional materials, such as lubricants or flavoring additives, dispersed therein. The edible sheets are configured to undergo a transformation and release the functional materials onto a cooking surface or surface of a food item, or into a mouth of a consumer, upon satisfaction of one or more predetermined conditions, allowing for consistent and controlled delivery of the functional materials. The edible sheets may be effective to flavor a food item before, during, or after cooking, may be effective to lubricate a food item or cooking surface, and/or may be effective to deliver a gustatory sensation to a consumer.

### CROSS-REFERENCE TO RELATED APPLICATION

This application is a continuation-in-part of U.S. patent application Ser. No. 17/214,109, filed 26 Mar. 2021, the entirety of which is incorporated herein by reference.

### FIELD OF THE INVENTION

The present disclosure is directed generally toward food flavoring and lubrication systems and methods, and more particularly toward systems and methods for imparting flavorings and/or lubrication agents to food items and/or cooking surfaces, and/or directly to a consumer.

### BACKGROUND OF THE INVENTION

In the practice of baking, cooking, or otherwise preparing food items, it is frequently necessary to provide a release agent and/or release material to enable easier removal of the food item from a cooking surface. By way of non-limiting example, in the preparation of a pizza, the uncooked pizza ingredients are generally placed in or on a pan before the pan is placed in a hot oven, and the pan may therefore need to be provided with a release agent and/or release material to ensure that the cooked pizza does not stick to the pan after removal from the oven. Typically, the release agent and/or release material is a lubricant, such as an oil.

The use of oils or greases (e.g. shortening) as release agents and/or release materials in baking and cooking presents various challenges. By way of non-limiting example, in commercial food service operations requiring efficient, high-speed preparation of food items, the use of oils or greases to lubricate food cooking surfaces may unacceptably delay or slow down the food preparation process. Oils and greases also represent a spill or contamination risk, which may in turn make the cooking environment more hazardous for food preparers (e.g. by presenting a slipping hazard if spilled on a floor). Moreover, such oils and greases are generally packaged in large, bulky, and/or heavy containers, which may be inconvenient and/or hazardous to work with. Furthermore, the dispensing and application of these release agents is difficult to control, highly variable, and operator-dependent, which can result in inconsistencies in food quality.

As an alternative to liquid lubricants as release agents and/or release materials, food ingredients in the form of a solid powder, such as cornmeal or semolina, may be used to lessen the degree of adhesion between an uncooked food item and a cooking surface. Frequently, however, such powdered ingredients may themselves stick to the food item, altering the taste and texture of the food item in ways that may be undesirable. These ingredients can also, in some cases, be difficult to work with from the standpoint of cleaning, contamination, and/or dust control. Other alternatives may include the use of non-stick cooking surfaces, e.g. pans coated with polytetrafluoroethylene (PTFE or Teflon), silicone (polysiloxane), or similar low-friction polymers, but such cooking surfaces are generally significantly more expensive and susceptible to damage than traditional cooking surfaces.

The use of edible films or sheets to impart a release agent and/or release material to a food item or cooking surface has recently become a focus of some research and commercial interest. Such films or sheets can also be used to impart a flavoring additive to a food item, and can be formulated to at least partially disintegrate upon application to a food item or cooking surface to impart the flavoring additive, release agent, and/or release material to the food item or cooking surface. However, while relatively rapid (i.e. on the order of seconds to minutes) dissolution or disintegration of such films or sheets is generally desired, this can adversely affect the films or sheets relative to storage, handling, and use of the films or sheets before and during the food preparation process should the dissolution or disintegration occur prematurely, resulting in the films or sheets being unusable.

Additionally, consumers may often find it desirable to experience a flavor or other gustatory sensation, e.g. by consuming an appropriately flavored food item. However, as there are many times and places in which eating or snacking is not socially acceptable, it is advantageous and beneficial to develop less obtrusive products for delivering a flavor to a consumer, and some such products, such as gums, mints, lozenges, hard candies, and the like, have been developed. But the use of these products is also not always socially acceptable; for example, gum is expressly banned from certain institutions, particularly schools. Gums, mints, lozenges, hard candies, and the like are also generally formulated to be used over extended periods of time; they therefore tend to dissolve or disintegrate slowly (or, in the case of most gums, not at all) in the mouth of the consumer, and they often require some degree of sucking or chewing action on the part of the consumer, which can be distracting, tedious, or otherwise undesirable. Perhaps most significantly of all from the consumer's perspective, mints, hard candies, and the like typically have a relatively high volumetric and/or areal density, resulting in a high calorie count for each unit consumed; for example, a single Jolly Rancher hard candy has a food energy content of about 25 calories and contains about four grams of sugar. It would thus be highly desirable to provide a snack or treat food that has a reduced calorie count—in some embodiments reduced by at least about 30% and preferably up to as much as about 70%—compared to a hard candy, mint, or like product delivering a similar gustatory sensation.

To the extent that flavored sprays or similar products have been developed to provide a quickly perceptible “burst” of a flavor to a consumer, the use of these sprays can be obtrusive. Administration of these products may often generate a noise, which may undesirably draw the attention of others to the consumer. Moreover, sprays and other liquids require greater care on the part of the consumer to store and transport, and/or more complex and expensive packaging, than one or more solid objects, such as mints and hard candies. Furthermore, misdirecting the spray of a flavored liquid not only wastes the product but can result in eye irritation or fouling of the consumer's skin or clothes.

### SUMMARY OF THE INVENTION

In an aspect of the present invention, an edible sheet for use in food preparation comprises a flexible or semi-rigid layer, comprising a food-safe solid base material; and a plurality of particles of a food-safe functional material, dispersed throughout the base material, wherein the edible sheet is configured such that, when a predetermined condition is satisfied, at least a portion of the particles of the functional material are released from the base material and are available to be transferred to a surface on which the edible sheet is disposed.

In embodiments, the particles of the functional material may be colloidally dispersed throughout the base material. The functional material may, but need not, be in the gas phase and the edible sheet may, but need not, be a solid foam. The functional material may, but need not, be in the liquid phase and the edible sheet may, but need not, be a gel. The functional material may, but need not, be in the solid phase and the edible sheet is a solid sol.

In embodiments, the base material may be an edible material that comprises at least one of a starch, a gelatin, an agar, a grain, a rice, a fruit, and a vegetable.

In embodiments, the base material may comprise at least one edible film-forming polymer. The at least one edible film-forming polymer may, but need not, be selected from the group consisting of pullulan, hydroxypropyl methylcellulose, carboxymethyl cellulose, hydroxypropyl cellulose, alginate, pectin, carrageenan, collagen, gelatin, starch, and gum arabic.

In embodiments, the flexible or semi-rigid layer may comprise a fiber matrix formed by the base material, and the particles of the functional material may be dispersed within the fiber matrix. The functional material may, but need not, be dispersed within the fiber matrix via vapor deposition.

In embodiments, the flexible or semi-rigid layer may comprise a plurality of perforations to allow a user to tear the edible sheet into multiple pieces having predetermined shapes.

In embodiments, the edible sheet may further comprise macroscopic, microscopic, and/or nanoscopic bubbles of one or more gases (e.g. air) dispersed throughout the base material. This feature may add a desired crispness or other texture to the edible sheet, as may be perceived, for example, by the consumer of a directly consumable sheet.

In embodiments, the edible sheet may further comprise at least one textured surface.

In embodiments, the predetermined condition may comprise at least one selected from the group consisting of (i) exposure to a solid or liquid having a moisture content exceeding a predetermined threshold or to a gas having a relative humidity exceeding a predetermined threshold, or exposure to water in an amount exceeding a predetermined threshold; (ii) a length of time after activation, creation, or manufacture of the edible sheet exceeding a predetermined threshold; (iii) a mechanical force exceeding a predetermined threshold; (iv) a temperature exceeding a predetermined threshold; (v) a temperature falling below a predetermined threshold; (vi) a sound characterized by a sound measurement parameter exceeding a predetermined threshold; (vii) movement of the edible sheet having a velocity or acceleration exceeding a predetermined threshold; and (viii) an electromagnetic phenomenon characterized by an electromagnetic parameter exceeding a predetermined threshold. The predetermined condition may, but need not, comprise (iv) and the predetermined threshold may, but need not, be at least about 90° C. The predetermined condition may, but need not, comprise (iv) and the predetermined threshold may, but need not, be between about 25° C. and about 37° C. The predetermined condition may, but need not, comprise (i), the base material may, but need not, comprise a water-soluble polymer, and the edible sheet may, but need not, be configured to release the at least a portion of the particles due to dissolution of at least a portion of the base material in water.

In embodiments, the functional material may be selected from the group consisting of a lubricant, a flavoring additive, and a moisturizing or moisture retention agent.

In another aspect of the present invention, a method for achieving a food preparation objective comprises (a) disposing an edible sheet on a cooking surface or a surface of a food item, the edible sheet comprising a flexible or semi-rigid layer, comprising a food-safe solid base material; and a plurality of particles of a food-safe functional material, dispersed throughout the base material, wherein the edible sheet is configured such that, when a predetermined condition is satisfied, at least a portion of the particles of the functional material are released from the base material and are available to be transferred to the cooking surface or the surface of the food item; and (b) causing the predetermined condition to be satisfied.

In embodiments, the particles of the functional material may be colloidally dispersed throughout the base material.

In embodiments, the base material may be an edible material that comprises at least one of a starch, a gelatin, an agar, a grain, a rice, a fruit, and a vegetable.

In embodiments, the flexible or semi-rigid layer may comprise a fiber matrix formed by the base material, and the particles of the functional material may be dispersed within the fiber matrix.

In embodiments, the flexible or semi-rigid layer may comprise a plurality of perforations to allow a user to tear the edible sheet into multiple pieces having predetermined shapes.

In embodiments, the edible sheet may further comprise macroscopic, microscopic, and/or nanoscopic bubbles of one or more gases (e.g. air) dispersed throughout the base material. This feature may add a desired crispness or other texture to the edible sheet, as may be perceived, for example, by the consumer of a directly consumable sheet.

In embodiments, the edible sheet may further comprise at least one textured surface.

In embodiments, the predetermined condition may comprise at least one selected from the group consisting of (i) exposure to a solid or liquid having a moisture content exceeding a predetermined threshold or to a gas having a relative humidity exceeding a predetermined threshold, or exposure to water in an amount exceeding a predetermined threshold; (ii) a length of time after activation, creation, or manufacture of the edible sheet exceeding a predetermined threshold; (iii) a mechanical force exceeding a predetermined threshold; (iv) a temperature exceeding a predetermined threshold; (v) a temperature falling below a predetermined threshold; (vi) a sound characterized by a sound measurement parameter exceeding a predetermined threshold; (vii) movement of the edible sheet having a velocity or acceleration exceeding a predetermined threshold; and (viii) an electromagnetic phenomenon characterized by an electromagnetic parameter exceeding a predetermined threshold. The predetermined condition may, but need not, comprise (i), and step (b) may, but need not, comprise wetting at least a portion of the edible sheet with water. The predetermined condition may, but need not, comprise (viii), and the electromagnetic phenomenon may, but need not, comprise at least one of exposure to a source of light energy having an illuminance exceeding a predetermined threshold and exposure to a source of thermal radiation having a heat flux exceeding a predetermined threshold.

In embodiments, at least one of the following may be true: (i) the food preparation objective is lubrication of a cooking surface and the functional material is a lubricant; (ii) the food preparation objective is flavoring a food item and the functional material is a flavoring additive; and (iii) the food preparation objective is increasing the moisture content or improving the moisture retention capacity of a food item and the functional material is a moisturizing or moisture retention agent.

In another aspect of the present invention, a directly consumable sheet comprises a flexible or semi-rigid layer, comprising a food-safe solid base material; and a plurality of particles of a flavoring additive, dispersed throughout the base material, wherein the directly consumable sheet is configured such that, when a predetermined condition is satisfied, at least a portion of the particles of the flavoring additive are released from the base material into a surrounding environment.

In embodiments, the particles of the flavoring additive may be colloidally dispersed throughout the base material. The flavoring additive may, but need not, be in the liquid phase and the directly consumable sheet may, but need not, be a gel. The flavoring additive may, but need not, be in the solid phase and the directly consumable sheet may, but need not, be a solid sol.

In embodiments, the base material may be an edible material that comprises at least one of a starch, a gelatin, an agar, a grain, a rice, a fruit, and a vegetable.

In embodiments, the base material may comprise at least one edible film-forming polymer. The at least one edible film-forming polymer may, but need not, be selected from the group consisting of pullulan, hydroxypropyl methylcellulose, carboxymethyl cellulose, hydroxypropyl cellulose, alginate, pectin, carrageenan, collagen, gelatin, starch, and gum arabic.

In embodiments, the flexible or semi-rigid layer comprises a fiber matrix formed by the base material, and the particles of the flavoring additive may be dispersed within the fiber matrix. The functional material may, but need not, be dispersed within the fiber matrix via vapor deposition.

In embodiments, the flexible or semi-rigid layer may comprise a plurality of perforations to allow a consumer to tear the directly consumable sheet into multiple pieces having predetermined shapes.

In embodiments, the surrounding environment may be a mouth of a consumer, and the predetermined condition may be satisfied upon placement of the directly consumable sheet in the mouth of the consumer. The predetermined condition may, but need not, comprise a temperature exceeding a predetermined threshold, and the predetermined threshold may, but need not, be at least about 25° C. and no more than about 37° C. The predetermined condition may, but need not, comprise exposure to moisture within the mouth of the consumer, the base material may, but need not, comprise a water-soluble polymer, and the directly consumable sheet may, but need not, be configured to release the at least a portion of the particles due to dissolution of at least a portion of the base material in an aqueous liquid present in the mouth of the consumer. The aqueous liquid may, but need not, be saliva.

In embodiments, the flavoring additive may comprise chocolate. The flavoring additive may, but need not, further comprise an herb, spice, or edible flower or portion thereof.

In another aspect of the present invention, a method for providing a gustatory sensation to a consumer comprises providing to the consumer a directly consumable sheet, comprising a flexible or semi-rigid layer, comprising a food-safe solid base material; and a plurality of particles of a flavoring additive, dispersed throughout the base material, wherein the directly consumable sheet is configured such that, when the consumer places the consumer in their mouth, a predetermined condition is satisfied, wherein, upon satisfaction of the predetermined condition, at least a portion of the particles of the flavoring additive are released from the base material into a surrounding environment.

In embodiments, the predetermined condition may comprise a temperature exceeding a predetermined threshold, and the predetermined threshold may be at least about 25° C. and no more than about 37° C.

In embodiments, the predetermined condition may comprise exposure to moisture within the mouth of the consumer, the base material may comprise a water-soluble polymer, and the directly consumable sheet may be configured to release the at least a portion of the particles due to dissolution of at least a portion of the base material in an aqueous liquid present in the mouth of the consumer. The aqueous liquid may, but need not, be saliva.

The advantages of the present invention will be apparent from the disclosure contained herein.

As used herein, “at least one,” “one or more,” and “and/or” are open-ended expressions that are both conjunctive and disjunctive in operation. For example, each of the expressions “at least one of A, B, and C,” “at least one of A, B, or C,” one or more of A, B, and C,” “one or more of A, B, or C,” and “A, B, and/or C” means A alone, B alone, C alone, A and B together, A and C together, B and C together, or A, B, and C together.

It is to be noted that the term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The embodiments and configurations described herein are neither complete nor exhaustive. As will be appreciated, other embodiments of the invention are possible utilizing, alone or in combination, one or more of the features set forth above or described in detail below.

### BRIEF DESCRIPTION OF THE DRAWINGS

FIG. 1A illustrated an edible sheet according to one or more embodiments of the present invention.

FIG. 1B illustrates an edible sheet according to one or more embodiments of the present invention.

FIG. 1C illustrates an edible sheet according to one or more embodiments of the present invention.

FIG. 2 illustrates an edible sheet according to one or more embodiments of the present invention.

FIG. 3 illustrates another edible sheet according to one or more embodiments of the present invention.

FIG. 4 illustrates another edible sheet according to one or more embodiments of the present invention.

### DETAILED DESCRIPTION OF THE INVENTION

Unless defined otherwise, all technical and scientific terms used herein have the same meaning as is commonly understood by one of ordinary skill in the art. All patents, applications, published applications, and other publications to which reference is made herein are incorporated by reference in their entirety. In the event that there is a plurality of definitions for a term herein, the definition provided in the Summary of the Invention prevails unless otherwise stated.

As used herein, unless otherwise specified, the term “colloid” refers to a mixture in which particles of one substance (the “dispersed phase”) are dispersed throughout a volume of a different substance (the “dispersion medium”). For example, the dispersed phase can comprise or consist of macroscopic, microscopic, and/or nanoscopic bubbles, particles, etc. Where the dispersed phase and the dispersion medium of a colloid are specifically identified herein, they are separated by a hyphen, with the dispersed phase identified first, e.g. a reference herein to an “oil-polymer colloid” refers to a colloid in which an oil is the dispersed phase and a polymer is the dispersion medium.

As used herein, unless otherwise specified, the terms “edible,” “ingestible,” and “orally consumable” are interchangeable and each refer to articles and substances that may be taken in by mouth and consumed (for example, by eating the article or substance, or allowing the article or substance to disintegrate or dissolve in the mouth) by a human being without negative side effects.

As used herein, unless otherwise specified, the term “emulsion” refers to a colloid in which both the dispersed phase and the dispersion medium are liquids. Examples of emulsions as that term is used herein include but are not limited to latex, lotion, mayonnaise, and milk.

As used herein, unless otherwise specified, the term “foam” refers to a colloid in which the dispersed phase is a gas and the dispersion medium is a liquid. Examples of foams as that term is used herein include but are not limited to shaving cream and whipped cream.

As used herein, unless otherwise specified, the term “gel” refers to a colloid in which the dispersed phase is a liquid and the dispersion medium is a solid. Examples of gels as that term is used herein include but are not limited to agar, gelatin, and jelly.

As used herein, unless otherwise specified, the term “liquid aerosol” refers to a colloid in which the dispersed phase is a liquid and the dispersion medium is a gas. Examples of liquid aerosols as that term is used herein include but are not limited to clouds, condensation, fog, hair spray, and mist.

As used herein, unless otherwise specified, the term “sol” refers to a colloid in which the dispersed phase is a solid and the dispersion medium is a liquid. Examples of sols as that term is used herein include but are not limited to pigmented ink.

As used herein, unless otherwise specified, the term “solid aerosol” refers to a colloid in which the dispersed phase is a solid and the dispersion medium is a gas. Examples of solid aerosols as that term is used herein include but are not limited to atmospheric particulates, ice clouds, and smoke.

As used herein, unless otherwise specified, the term “solid foam” refers to a colloid in which the dispersed phase is a gas and the dispersion medium is a solid. Examples of solid foams as that term is used herein include but are not limited to aerogel, pumice, and Styrofoam.

As used herein, unless otherwise specified, the term “solid sol” refers to a colloid in which both the dispersed phase and the dispersion medium are solids. Examples of solid sols as that term is used herein include but are not limited to cranberry glass.

Given the above-described challenges and shortcomings, it is desirable to provide edible films or sheets that can be used to impart a flavoring additive, release agent, and/or release material to a food item or cooking surface over an extended period that enables the flavoring additive, release agent, and/or release material to persist on the cooking surface or within or on a surface of the food item after dissolution or disintegration of the film or sheet, without the need to remove the film or sheet or undertake other time-consuming or labor-intensive steps prior to consumption of the food item. It is further desirable to provide simple, clean, efficient, and food-safe systems and methods for flavoring and/or lubricating a food item and/or cooking surface. It is still further desirable to provide systems and methods for flavoring and/or lubricating a food item and/or cooking surface that improve kitchen contaminant control and food product quality. It is still further desirable to provide systems and methods for flavoring and/or lubricating a food item and/or cooking surface that ensure a consistent and uniform amount, level, or quantity of flavoring or lubrication with each use, e.g. across each of multiple cooking locations or sessions. It is still further desirable to provide edible films or sheets that can be used to delivering a flavor directly into the mouth of a consumer over a relatively brief period that enables the flavor to be perceived by the consumer after dissolution or disintegration of the film or sheet in the consumer's mouth. It is still further desirable to provide edible films or sheets that can include small, solid pieces of one or more food items (e.g. chocolate nibs, nut pieces, particles of an herb or spice, etc.), which may contribute to both the flavor and a texture (e.g. a crunchy texture) of the edible film or sheet. It is still further desirable to provide simple, clean, and efficient systems and methods for delivering a flavor directly into the mouth of a consumer while minimizing the risk of contamination. It is still further desirable to provide systems and methods for delivering a flavor directly into the mouth of a consumer that ensure a consistent and uniform amount, level, or quantity of the flavoring. It is still further desirable to provide systems and methods for delivering a flavor directly into the mouth of a consumer that is unobtrusive to use, can at least partially dissolve or disintegrate immediately or quickly upon placement in the consumer's mouth (i.e. does not require the consumer to suck or chew to begin releasing the flavor), can be easily stored and transported, can quickly (e.g. within between about 1 second and about 1 minute after placement in the consumer's mouth) deliver an enjoyable gustatory sensation to the consumer, and/or has an improved nutritional profile compared to snacks or other food items that may be characterized by the same or a similar flavor.

To address these and other needs in the art, embodiments of the present invention include edible sheets comprising one or more flexible or semi-rigid membranes or layers, such membranes or layers acting as a dispersion medium in which particles of one or more functional materials (e.g. flavoring additives (which may in some embodiments comprise solid pieces, e.g. nut pieces, particles of an herb or spice, etc.), cooking surface lubricants, etc.) are dispersed. The membranes or layers may, in embodiments, have a Young's modulus (stiffness) comparable to conventional rubbers, polymer foams, and/or low-density polyethylenes, which may in embodiments be between about 0.01 GPa and about 10 GPa, and/or the membranes or layers may, in embodiments, have a flexural stiffness of less than about 5 g/cm, less than about 4 g/cm, less than about 3 g/cm, less than about 2 g/cm, or less than about 1 g/cm, often between about 0.1 g/cm and about 1 g/cm. The membranes or layers may also, in certain embodiments, have a “crisp” character, i.e. be brittle, friable, and/or adapted to be broken via one or more short, sharp fractures, in a manner akin to a potato chip or nori sheet. In these embodiments, the sheet as a whole can thus be considered a colloid, as that term is used herein. The edible sheets of the present invention are configured to undergo a transformation to release and/or transfer the functional material onto a cooking surface during a food preparation process, or into or onto a food item during a food preparation process, or into the mouth of a consumer when placed there by the consumer, thereby providing the function of the functional material(s) (flavoring, lubrication, moisture, etc.).

The flexible or semi-rigid membranes or layers of the edible sheets of the present invention are, under ambient conditions, typically in solid form, but it is to be expressly understood that they may (but need not), as a result of the transformation which the edible sheets are configured to undergo during the food preparation process and/or after being placed in a consumer's mouth, be transformed into liquid form (e.g. by melting, dissolution, chemically-induced disintegration, etc.) or gas form (e.g. by sublimation, or by evaporation after first melting into liquid form). The particles of the functional material(s) dispersed throughout such membranes or layers, meanwhile, may be in gas, liquid, or solid form under ambient conditions, and may likewise (but need not) undergo phase change as a result of the transformation. Thus, under ambient conditions and prior to any transformation, an edible sheet according to the present invention can be a solid foam (i.e. the at least one functional material is in gas form), a gel (i.e. the at least one functional material is in liquid form), a solid sol (i.e. the at least one functional material is in solid form), or a combination of these (i.e. where the edible sheet comprises two or more functional materials in different phases of matter).

The edible sheets of the present invention are configured such that, upon undergoing a transformation, the particles of the functional material(s) dispersed throughout the one or more flexible or semi-rigid membranes or layers are released from the edible sheet and transferred onto a cooking surface on which the edible sheet has been placed, into or onto a food item on which the edible sheet has been placed, and/or into the mouth of a consumer into which the edible sheet has been placed. When applied to a cooking surface and/or food item as a part of a food preparation process, the particles of the functional material(s) can, upon transformation, be either adsorbed onto the cooking surface or food item (i.e. transferred to and residing on the surface of the solid cooking surface or liquid or solid food item) or absorbed into the bulk of the liquid or solid food item (e.g. by dissolution or diffusion). When placed in the mouth of a consumer, the particles of the functional material(s), which generally include one or more flavoring additives, can, upon transformation, come into contact with the gustatory cells contained within the soft tissues of the consumer's mouth and thereby cause the flavor to be perceived by the consumer. It is to be expressly understood that, in embodiments in which the functional material(s) are released as a result of disintegration or dissolution of the base material, the particles of functional material(s) may (e.g. where the functional material is in the form of a water-soluble liquid and the edible sheet is configured to undergo a moisture-induced transformation) or may not (e.g. where the functional material is in the form of solid particles) themselves dissolve.

The transformation which the edible sheets of the present invention are configured to undergo may take place upon a satisfaction of a predetermined condition or a predetermined change in any one or more conditions. By way of first non-limiting example, the transformation may be a moisture content-induced transformation, whereby the edible sheet is configured to release the functional material(s) if and when exposed to a surface (e.g. a cooking surface or surface of a food product) or environment (e.g. the mouth of a consumer) whose moisture content exceeds a preselected value (e.g. at least about 10 wt % water or 10% relative humidity), or is below a preselected value, or is within a preselected range; embodiments of this type may be particularly suitable for, e.g., applications in which the edible sheet is intended to be applied to a primarily liquid food item (a beverage, broth, soup, etc.), applications in which a solid food item has a high surface and/or total moisture content (e.g. raw meat), and/or applications in which the edible sheet is intended to be placed in the mouth of a consumer to deliver a flavor to be perceived by the consumer. By way of second non-limiting example, the transformation may be a time-induced transformation, whereby the edible sheet is configured to release the functional material(s) a preselected period of time after activation, creation, or manufacture of the edible sheet. By way of third non-limiting example, the transformation may be an energy-induced transformation, whereby the edible sheet is configured to release the functional material(s) if and when exposed to a source of energy, which may in some embodiments be light or another form of electromagnetic energy.

In some embodiments, the edible sheet may be configured to undergo a kinetic energy-induced transformation. In these embodiments, the edible sheet may be configured to release the functional material(s) when a mechanical force exceeding a predetermined threshold is applied thereto. Non-limiting examples of the type of mechanical force that may be applied to the edible sheet to effect the transformation include a frictional force, e.g. a force applied by rubbing or sliding the edible sheet against the food item, cooking surface, teeth or oral tissues of a consumer, or another object; a tension force, e.g. a force applied by pulling opposite ends, edges, or layers of the edible sheet axially away from each other; a compression force, e.g. a force applied by pushing opposite ends, edges, or layers of the edible sheet axially toward each other; a shearing force, e.g. a force applied by twisting or tearing one portion of the edible sheet relative to another portion of the edible sheet; a fluid pressure force, e.g. a static or dynamic pressure exerted on the edible sheet by a fluid; and the like.

In some embodiments, the edible sheet may be configured to undergo a thermal energy-induced transformation. In these embodiments, the edible sheet may be configured to release the functional material(s) when heated to a temperature above, or cooled to a temperature below, a predetermined threshold temperature. By way of first non-limiting example, the edible sheet may be configured to release the functional material(s) when heated to a temperature of at least about 20° C., at least about 30° C., at least about 40° C., at least about 50° C., at least about 60° C., at least about 70° C., at least about 80° C., at least about 90° C., at least about 100° C., at least about 110° C., at least about 120° C., at least about 130° C., at least about 140° C., at least about 150° C., at least about 160° C., at least about 170° C., at least about 180° C., at least about 190° C., at least about 200° C., at least about 210° C., at least about 220° C., at least about 230° C., at least about 240° C., at least about 250° C., or at least about 260° C. By way of second non-limiting example, the edible sheet may be configured to release the functional material(s) when cooled to a temperature of less than about 20° C., less than about 10° C., less than about 0° C., less than about −10° C., or less than about −20° C.

In some embodiments, the edible sheet may be configured to undergo a sound-induced or microwave radiation-induced transformation. In some such embodiments, the edible sheet may be configured to release the functional material(s) when exposed to a sound pressure exceeding a predetermined sound pressure threshold, a sound intensity exceeding a predetermined sound intensity threshold, a sound power exceeding a predetermined sound power threshold, a sound energy or sound energy density exceeding a predetermined sound energy or sound energy density threshold, a sound exposure exceeding a predetermined sound exposure threshold, a microwave radiation exceeding a predetermined microwave radiation threshold, or microwave radiation for more than a predetermined amount of time. Additionally or alternatively, the edible sheet may be configured to release the functional material(s) when exposed to a preselected tone or pitch of sound, e.g. a sound having a selected frequency; in embodiments, the frequency may be an infrasonic frequency (i.e. below the range of human hearing, or having a frequency of less than about 20 Hz), an audio frequency (i.e. within the range of human hearing, or having a frequency of between about 20 Hz and about 20 kHz), or an ultrasonic frequency (i.e. above the range of human hearing, or having a frequency of more than about 20 kHz).

In some embodiments, the edible sheet may be configured to undergo a motion-induced transformation. In these embodiments, the edible sheet may be configured to release the functional material(s) when the sheet is moved, translated, or transported in a preselected way, or with a preselected velocity or acceleration, for example when the sheet is accelerated by at least about 10 m/s².

In some embodiments, the edible sheet may be configured to undergo an electromagnetically-induced transformation. In these embodiments, the edible sheet may be configured to release the functional material(s) when exposed to an electric charge exceeding a predetermined electric charge threshold, an electric current exceeding a predetermined electric current threshold, an electric field exceeding a predetermined electric field threshold, an electric potential exceeding a predetermined electric potential threshold, an electric power exceeding a predetermined electric power threshold, a magnetic field exceeding a predetermined magnetic field threshold, or an electromagnetic field exceeding a predetermined electromagnetic field threshold.

In some embodiments, the edible sheet may be configured to undergo a moisture-induced transformation. In these embodiments, the edible sheet may be configured to release the functional material(s) when exposed to a moisture content exceeding a predetermined moisture threshold. By way of first non-limiting example, the edible sheet may be configured to release the functional material(s) when a surface thereof contacts a solid or liquid that is at least about 5 wt % water, at least about 10 wt % water, at least about 15 wt % at least about 20 wt % water, at least about 25 wt % water, at least about 30 wt % water, at least about 35 wt % water, at least about 40 wt % water, at least about 45 wt % water, at least about 50 wt % water, at least about 55 wt % water, at least about 60 wt % water, at least about 65 wt % water, at least about 70 wt % water, at least about 75 wt % water, at least about 80 wt % water, at least about 85 wt % water, at least about 90 wt % water, at least about 95 wt % water, at least about 96 wt % water, at least about 97 wt % water, at least about 98 wt % water, or at least about 99 wt % water. By way of second non-limiting example, the edible sheet may be configured to release the functional material(s) when a surface thereof contacts a gas that has a relative humidity of at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 96%, at least about 97%, at least about 98%, or at least about 99%. By way of third non-limiting example, the edible sheet may be configured to release the functional material(s) when a surface thereof is in contact with water in an amount of at least about 1 gram per square meter, at least about 2 grams per square meter, at least about 3 grams per square meter, at least about 4 grams per square meter, at least about 5 grams per square meter, at least about 6 grams per square meter, at least about 7 grams per square meter, at least about 8 grams per square meter, at least about 9 grams per square meter, at least about 10 grams per square meter, at least about 20 grams per square meter, at least about 30 grams per square meter, at least about 40 grams per square meter, at least about 50 grams per square meter, at least about 60 grams per square meter, at least about 70 grams per square meter, at least about 80 grams per square meter, at least about 90 grams per square meter, or at least about 100 grams per square meter. A user of the edible sheet may induce the transformation by any suitable means of applying the required moisture to the edible sheet, e.g. placing the sheet under a tap or other source of running water, pouring water from a vessel onto the sheet, spraying water onto the sheet using a spray bottle or similar applicator, placing the sheet in his or her mouth to expose the sheet to the user's saliva, and the like.

In some embodiments, the edible sheet may be configured to undergo a time-induced transformation. In these embodiments, the edible sheet may be configured to release the functional material(s) a preselected period of time after activation, creation, or manufacture of the edible sheet. By way of non-limiting example, the preselected period of time may be about 30 seconds, about 30 seconds, about 40 seconds, about 50 seconds, about 1 minute, about 2 minutes, about 3 minutes, about 4 minutes, about 5 minutes, about 10 minutes, about 15 minutes, about 20 minutes, about 25 minutes, about 30 minutes, about 35 minutes, about 40 minutes, about 45 minutes, about 50 minutes, about 55 minutes, about 1 hour, about 2 hours, about 3 hours, about 4 hours, about 5 hours, about 6 hours, about 7 hours, about 8 hours, about 9 hours, about 10 hours, about 11 hours, about 12 hours, about 13 hours, about 14 hours, about 15 hours, about 16 hours, about 17 hours, about 18 hours, about 19 hours, about 20 hours, about 21 hours, about 22 hours, about 23 hours, or about 24 hours.

It is to be expressly understood that the edible sheets of the present invention may be configured to undergo transformation upon satisfaction of multiple conditions or a combination of conditions. By way of non-limiting example, an edible sheet may be configured to undergo a “time at temperature”-induced transformation (i.e. to release the functional material(s) after being heated to or above, or cooled to or below, a preselected temperature and held at such temperature for a preselected period of time), a “time at moisture”-induced transformation (i.e. to release the functional material(s) after having been in contact with a material having at least a preselected moisture content for a preselected period of time), a “temperature and moisture”-induced transformation (i.e. to release the functional materials upon satisfaction of both a preselected temperature parameter and a preselected moisture or relative humidity parameter), a “moisture and time”-induced transformation (i.e. to release the functional materials a preselected period of time, or at a preselected rate, after having been in contact with a material having at least a preselected moisture content, e.g. by at least partially immersing or submerging the edible sheet in a volume of water, a beverage, a broth, or the like), and so on.

Likewise, it is to be expressly understood that the present invention encompasses “multifunctional” edible sheets comprising multiple functional materials, which may be configured to release the two or more functional materials simultaneously (i.e. upon satisfaction of the same condition or set of conditions) or separately (i.e. upon satisfaction of different conditions or sets of conditions); “incremental” edible sheets comprising multiple separate aliquots of functional material(s) and configured to release the separate aliquots upon satisfaction of different conditions or sets of conditions; “controlled-release” edible sheets configured to release the functional material(s) at a predetermined rate so long as the condition or sets of conditions triggering the transformation is/are satisfied; and combinations of these. Multifunctional, incremental, and controlled-release edible sheets according to the present invention may, but need not, provide different functional materials and/or separate aliquots of a single functional material in separate layers or membranes.

In embodiments, a multilayer edible sheet may be provided in which each of two or more layers may be individually “tuned” or “biased” toward a particular type of transformation and/or cooking function, such that the multilayer sheet is effective to achieve a combination of functions, or to apply the same function to each of two or more food items. By way of first non-limiting example, a multilayer edible sheet adapted to be used with both raw chicken and raw pork may include a layer that is “tuned” or “biased” to undergo a moisture-induced transformation for use with raw chicken (which generally has a very high surface moisture content) and a separate layer that is “tuned” or “biased” to undergo a different type of transformation, e.g. a temperature-induced transformation, for use with raw pork (which is much “drier,” i.e. has a much lower surface moisture content). By way of second non-limiting example, a multilayer sheet adapted to deliver both a liquid flavoring ingredient (e.g. an oil, a glaze, a plant-derived extract or essence, etc.) and a solid flavoring ingredient may include a layer that is adapted to serve as a dispersion medium for the liquid flavoring ingredient and a separate layer that is sufficiently hydrophilic to serve as a dispersion medium for, and uniformly distribute across the surface of a food item, coarsely and/or finely ground particles of a solid herb or spice.

The precise mechanism or mechanisms by which the edible sheet is transformed may vary within the scope of the present invention, and any suitable mechanism or combination of mechanisms that allows for a desired release profile of the functional material(s) onto the cooking surface, into or onto the food item, or into the mouth of the consumer may be provided for. By way of first non-limiting example, the transformation may comprise a phase change (melting, sublimation, etc.) of the material(s) of the flexible or semi-rigid membrane(s) or layer(s) of the edible sheet, whereby the particles of the dispersed functional material(s) (whether in solid, liquid, or gas form) may escape from the edible sheet as a result of the phase change. By way of second non-limiting example, the transformation may comprise a phase change (melting, sublimation, etc.) of the functional material particles themselves, e.g. from a solid form having a lower diffusivity through the material of the membrane(s)/layer(s) to a liquid or gas form having a higher diffusivity through the material of the membrane(s)/layer(s). By way of third non-limiting example, the transformation may comprise altering the diffusivity of the functional material particles through the material of the membrane(s)/layer(s) without a phase change, e.g. by increased temperature or pressure. By way of fourth non-limiting example, the transformation may comprise dissolution of the material(s) of the membrane(s)/layer(s) of the edible sheet in a solvent (e.g. water) present on the cooking surface, the surface of the food item, or a surface of an oral tissue of a consumer, thereby freeing the functional material particles from the matrix of the membrane(s)/layer(s). By way of fifth non-limiting example, the transformation may comprise infiltration of the membrane(s)/layer(s) by a solvent (e.g. water) present on the cooking surface, the surface of the food item, or a surface of an oral tissue of a consumer, whereby such solvent dissolves the functional material particles and carries the functional material(s) out of the edible sheet. By way of sixth non-limiting example, the transformation may comprise an osmotic mechanism, whereby the edible sheet comprises one or more semipermeable and/or selective permeable membranes or layers through which a solvent (e.g. water) present on the cooking surface, the surface of the food item, or a surface of an oral tissue of a consumer is absorbed and the functional material(s) is/are then forced out of the edible sheet and onto the cooking surface, the surface of the food item, or the surface of the oral tissue of the consumer by osmotic pressure. By way of seventh non-limiting example, the membrane(s)/layer(s) of the edible sheet may comprise an ion exchange resin to which the functional material particles are attached, and the functional material(s) may thus be released upon an interaction of the ion exchange resin with ions present on the cooking surface, the surface of the food item, or the surface of an oral tissue of a consumer (e.g. Na⁺ ions or Cl⁻ ions present on the surface of a salty food). By way of eighth non-limiting example, the transformation may comprise chemical or physical degradation or erosion of a matrix material (e.g. a hydrophobic material, a hydrophilic material, a lipid material, a biodegradable material, a mineral material, etc.) of the membrane(s)/layer(s) of the edible sheet by a substance (e.g. water, an acid, a base, an enzyme, etc.) present on the cooking surface, the surface of the food item, or the surface of an oral tissue of a consumer. By way of ninth non-limiting example, the transformation may comprise a disruption of a matrix or network of the membrane(s)/layer(s) (e.g. a matrix or network of crosslinked or entangled polymers, entangled or enmeshed fibers, etc.), by chemical or physical means, that enables the functional material to move more freely through and out of the matrix or network and onto the cooking surface, the surface of the food item, or the surface of an oral tissue of a consumer. By way of tenth non-limiting example, the transformation may comprise causing a transition in the membrane/layer material(s) and/or the functional material(s) from a crystalline state to an amorphous state or vice versa, or from one crystal structure to another crystal structure. It is to be expressly understood that edible sheets according to the present invention, and particularly multifunctional, incremental, and controlled-release sheets, may be configured to undergo transformations by any combination of two or more of these and other mechanisms.

In embodiments, edible sheets according to the present invention may be configured to undergo transformation by physically breaking down or being otherwise disrupted, thereby releasing the functional material(s). Particularly, edible sheets according to the present invention may incorporate fillers (e.g. starches), and/or incorporate one or more edible polymers, to form a matrix or network that is disrupted during a cooking process. These fillers and/or edible polymer materials may facilitate the breakdown of the edible sheet by any one or more mechanisms, such as, by way of non-limiting example, dissolution (e.g. of a water-soluble filler or polymer by moisture present on a surface of a food item or cooking surface or in the mouth of a consumer), melting or other thermally-induced change (e.g. upon exposure to the high temperatures of cooking or baking), and the like. It is to be expressly understood that edible sheets may be configured to undergo physical breakdown or disruption by two or more mechanisms; by way of non-limiting example, at least a portion of the sheet may be configured to undergo a moisture-induced breakdown or disruption (e.g. dissolution of a water-soluble filler or polymer), and at least a portion of the sheet (which may be the same or a different portion) may be configured to undergo a thermally-induced transformation (e.g. melting upon exposure to a hot cooking surface, steam, body heat of a consumer, etc.), to ensure complete breakdown of the sheet and release of substantially all of the functional material(s).

Most generally, the material(s) from which the flexible or semi-rigid membranes or layers of edible sheets of the present invention are made can be any food-safe material suitable for dispersion of the selected functional material(s). Typically, however, these materials will most suitably be an edible film-forming polymer, or a combination of two or more edible film-forming polymers, due to their safety for use in food preparation, convenience, relatively low cost, and ease of manufacturing edible sheets by various well-known methods (coating, extrusion, casting, sputtering, printing, etc.). Even more specifically, it may in some embodiments be desirable to select one or more water-soluble film-forming edible polymers, such as a water-soluble polysaccharide, as a material from which to construct the flexible or semi-rigid membranes or layers; as human mouths and most food items contain a significant quantity of moisture, the use of water-soluble polymers may improve the extent to which the edible film dissolves or disintegrates during food preparation and/or after being placed in a consumer's mouth, which may be desirable in many applications. Examples of water-soluble film-forming polymers suitable for use in the flexible or semi-rigid membranes or layers of edible sheets of the present invention include, but are not limited to, pullulan, hydroxypropyl methylcellulose (hypromellose or HPMC), carboxymethyl cellulose (CMC), hydroxypropyl cellulose (HPC), starch, gum arabic, and hydrocolloids (e.g. alginate, pectin, carrageenan, and the like). In some embodiments, one or more film-forming edible polymers that are insoluble in water (e.g. protein-based insoluble polymers, such as collagen) or soluble in water only under select conditions (e.g. protein-based polymers whose solubility in water is highly temperature-dependent, such as gelatin) may be provided instead of, or in addition to, the one or more water-soluble film-forming edible polymers to provide an additional or alternative mechanism for the breakdown or transformation of at least a portion of the edible sheet; by way of non-limiting example, collagen may be provided as part of the edible sheet to provide a thermally-induced transformation mechanism, as collagen may melt more readily than the functional material(s) (and, in some embodiments, other edible film-forming polymers) provided in the edible sheet. In addition to these non-limiting examples, development of new polysaccharide-, peptide-, and/or lipid-based polymers is ongoing, and it is to be expressly understood that edible film-forming polymers currently being developed or to be developed in the future may be used in edible sheets of the present invention without departing from the scope of the invention. It is to be further expressly understood that those of ordinary skill in the art can select an appropriate edible film-forming polymer based on desired properties of the transformation of the edible sheet and release of the functional material(s).

The functional material(s) of edible sheets according to the present invention may be any food-safe material, typically a solid or liquid material, suitable for providing a function (e.g. flavoring, lubrication, moisture, etc.) to a food item or a cooking surface on which a food item is to be prepared, or for dispensing a flavoring into the mouth of a consumer. Functional material(s) according to the present invention may include one or more flavoring ingredients, non-limiting examples of which include chocolate (and/or cocoa, and/or cacao), salt (sodium chloride), herbs (e.g. angelica, anise hyssop, basils (such as anise basil or cinnamon basil), bay, chile, damiana, garlic, mints (such as orange mint, peppermint, or spearmint), oats, oregano, parsley, rose, rosemary, sage, tarragon, tea, and so on), spices (e.g. anise seed, cardamom, cinnamon, clove, coffee, coriander, ginger, mace, nutmeg, star anise, vanilla, and so on), edible flowers or pieces or portions thereof (e.g. lavender flowers, rose petals, pansies, violets, lilacs, scented geraniums (such as rose geranium, coconut geranium, mint geranium, nutmeg geranium, and orange geranium)), naturally derived sweeteners (e.g. white sugar, brown sugar, caramel, honey, molasses, allulose, stevia, etc.), and the like. Additionally or alternatively, functional material(s) according to the present invention may include one or more food-safe lubricants, such as meat fats, dairy fats, vegetable fats, fish oils, and/or vegetable oils; non-limiting examples of such lubricants include coconut oil, corn oil, cottonseed oil, olive oil, palm oil, peanut oil, rapeseed oil, safflower oil, soybean oil, and sunflower oil. Additionally or alternatively, functional material(s) according to the present invention may include one or more food-safe moisturizing and/or moisture retention agents, non-limiting examples of which includes water, sugars and sugary ingredients (e.g. white sugar, brown sugar, caramel, honey, molasses, etc.), and chemical salts (e.g. sodium chloride, calcium chloride, etc.). Additionally or alternatively, functional material(s) according to the present invention may include one or more nutrients, non-limiting examples of which include vitamins and dietary minerals. It is to be expressly understood that edible sheets according to the present invention may include more than one functional material having the same or different functions, and/or that a single functional material may serve more than one of these and/or other functions (e.g. sodium chloride may act as both a flavoring ingredient and a moisture retention agent). Functional materials may be provided in the edible sheets of the present invention in any one or more suitable physical forms, including but not limited to finely ground solids, coarsely ground solids, liquids, oleoresins, essential oils, and so on.

In embodiments described herein, an edible sheet may be a food-safe product, or even a product specifically adapted to be eaten together with or as part of a food item. In some embodiments, the edible sheet may comprise one or more of a starch, a gelatin, an agar, a grain, a rice, a fruit, and/or a vegetable. The edible sheet may be a raw product, or it may be processed in some manner prior to use, e.g. by cooking, freeze-drying, etc. The edible sheet may comprise natural and/or artificial flavoring. The edible sheet may comprise natural and/or artificial coloring. The flexible or semi-rigid membrane(s) or layer(s) of the edible sheet within which the functional material(s) is/are dispersed may comprise a matrix of a dissolvable and edible substrate. Additionally or alternatively, the flexible or semi-rigid membrane(s) or layer(s) of the edible sheet may comprise an edible and/or dissolvable fiber-based structure. In some embodiments, the edible sheet may be a product specifically adapted to be eaten or otherwise orally consumed alone, i.e. without an accompanying food item.

In some embodiments, the edible sheet may be in the form of a relatively thin film (e.g. having a thickness of no more than about 20 millimeters, or of no more than about 10 millimeters, or of no more than about 9 millimeters, or of no more than about 8 millimeters, or of no more than about 7 millimeters, or of no more than about 6 millimeters, or of no more than about 5 millimeters, or of no more than about 4 millimeters, or of no more than about 3 millimeters, or of no more than about 2 millimeters, or of no more than about 1.75 millimeters, or of no more than about 1.5 millimeters, or of no more than about 1.25 millimeters, or of no more than about 1 millimeter, or of no more than about 0.95 millimeters, or of no more than about 0.9 millimeters, or of no more than about 0.85 millimeters, or of no more than about 0.8 millimeters, or of no more than about 0.75 millimeters, or of no more than about 0.7 millimeters, or of no more than about 0.65 millimeters, or of no more than about 0.6 millimeters, or of no more than about 0.55 millimeters, or of no more than about 0.5 millimeters, or of no more than about 0.45 millimeters, or of no more than about 0.4 millimeters, or of no more than about 0.35 millimeters, or of no more than about 0.3 millimeters, or of no more than about 0.25 millimeters, or of no more than about 0.2 millimeters, or of no more than about 0.15 millimeters, or of no more than about 0.1 millimeters), whereas in other embodiments the edible sheet may be relatively thick (e.g. having a thickness of at least about 10 centimeters). The edible sheet may also take any suitable shape depending on an intended or expected use, which may in embodiments include a circular shape, a rectangular shape, or any other suitable shape. In some embodiments, the edible sheet may include perforations that allow a user to tear the edible sheet into smaller pieces having a desired size and/or shape if less than the entire sheet is needed for a particular application. In some embodiments, the edible sheet may have a spatially varying thickness and/or a non-planar three-dimensional shape to conform to a non-planar cooking surface (e.g. certain types of baking tin or pan), to multiple surfaces of a cooking vessel having at least one planar surface (e.g. a pot or skillet), and/or to a non-planar surface or multiple planar surfaces of tissues inside the mouth of a consumer. In some embodiments, the edible sheet may be provided in the form of relatively small pieces, e.g. confetti, dots, flakes, shavings, strips, etc. such that a plurality of such pieces may be used in a manner similar to a single larger planar sheet. Additionally or alternatively, the sheet may be provided with a textured surface, such as, for example, a ridged or corrugated surface, which may provide any of several advantages and benefits (e.g. increased surface area contact with the food item, cooking surface, or oral tissues of the consumer, increased friction and therefore reduced chance of the sheet slipping or sliding prior to transformation, and so on). In some embodiments, the sheet may be adapted to be consumed directly by the end user/consumer, either with or without an accompanying food product; accordingly, a texture may be provided to enhance the experience of eating the sheet.

In some embodiments, an edible sheet may comprise an edible or inedible substrate or carrier layer. For example, an edible sheet may comprise a thin layer of one or more of a fiber, a starch, a gelatin, an agar, a grain, a rice, a fruit, and/or a vegetable. The thin layer may be placed on an edible or inedible substrate or carrier layer, e.g. a paper layer, a plastic layer, a baking vessel (e.g. a meal, ceramic, or glass baking dish), or another layer comprising one or more of a starch, a gelatin, an agar, a grain, a rice, a fruit, and/or a vegetable. The substrate or carrier layer may be used for packaging and/or handling the edible sheet. In some embodiments, the substrate or carrier layer may be removed by a user prior to using the edible sheet in the preparation of food and/or prior to placing the edible sheet in his or her mouth. In some embodiments, the substrate or carrier layer may be optional. In some embodiments, the substrate or carrier layer may itself be configured to undergo a transformation upon satisfaction of the same or different conditions needed to trigger a transformation in the other layers of the edible sheet, e.g. the substrate or carrier layer may be configured to dissolve or disintegrate upon exposure to heat and/or moisture.

Edible sheets according to the present invention may be prepared or manufactured to have a relatively low water activity, e.g. less than about 0.85, less than about 0.8, less than about 0.75, less than about 0.7, less than about 0.65, less than about 0.6, less than about 0.55, less than about 0.5, less than about 0.45, less than about 0.4, less than about 0.35, less than about 0.3, less than about 0.25, less than about 0.2, less than about 0.15, less than about 0.1, less than about 0.05, less than about 0.04, less than about 0.03, less than about 0.02, or less than about 0.01. A relatively low water activity may provide any one or more of several advantages and benefits, but most particularly may maximize the shelf life of the edible sheet by, e.g., slowing water-induced damage or deterioration of the edible sheet and preventing the proliferation of microbes, including pathogenic microbes, in or on the edible sheet. Other advantages of relatively low water activity may include, but are not necessarily limited to, resistance to browning or maintenance of a “crisp” texture for a longer time in storage. In embodiments, the low water activity of edible sheets of the present invention may allow the edible sheet to have a useful shelf life, under typical storage conditions, of at least about one month, at least about two months, at least about three months, at least about four months, at least about five months, at least about six months, at least about seven months, at least about eight months, at least about nine months, at least about ten months, at least about eleven months, or at least about twelve months.

Additionally or alternatively, edible sheets according to the present invention may be prepared or manufactured to have a relatively low moisture content, e.g. a content of less than about 50 wt % water, less than about 45 wt % water, less than about 40 wt % water, less than about 35 wt % water, less than about 30 wt % water, less than about 25 wt % water, less than about 20 wt % water, less than about 15 wt % water, less than about 10 wt % water, less than about 5 wt % water, less than about 4 wt % water, less than about 3 wt % water, less than about 2 wt % water, or less than about 1 wt % water. These low moisture contents may likewise provide extended shelf life to the edible sheets of the invention, among other advantages and benefits.

### Directly Consumable Sheets

Embodiments of the present invention include edible sheets that are configured, and particularly well adapted, to undergo a transformation as described herein by at least partially disintegrating or dissolving in the mouth of a consumer, and in some embodiments to adhere to the surfaces of tissues inside the consumer's mouth. These edible sheets, referred to hereinafter as “directly consumable sheets,” can therefore be effective to deliver a desired flavor or gustatory sensation to the consumer. In some embodiments, flavoring additives present in directly consumable sheets may include chocolate or chocolate-flavored additives (e.g. cocoa or cacao), alone or in combination with one or more other flavoring additives such as herbs, spices, nuts, seeds, etc.

In addition to the tongue, human beings possess taste receptors in the tissues of the soft palate, upper esophagus, cheek, and epiglottis. The directly consumable sheets of the present invention may therefore be more effective to deliver a desired flavor or gustatory sensation to a consumer in the sense that these sheets may adhere to or coat more than one taste-sensitive surface in the consumer's mouth, and/or the base material (i.e. the material of which the flexible or semi-rigid layers are made) may rapidly dissolve or disintegrate to release the one or more flavoring additives (in solid or liquid form) onto more than one taste-sensitive surface in the consumer's mouth. These advantages are not always possible with gums, mints, lozenges, hard candies, and the like; the directly consumable sheets of the invention therefore allow a consumer to perceive a desired flavor or gustatory sensation more quickly and/or efficiently, and/or in a more effective, more portable, and less obtrusive form, and/or in a form with an improved nutritional profile (e.g. low in carbohydrates, sugars, calories, fat, etc.) compared to conventional snack or treat foods.

In some embodiments, directly consumable sheets of the present invention may optionally have a texture that may allow or even encourage the consumer to bite or chew the directly consumable sheet upon placement of the sheet in the consumer's mouth. In these embodiments, it may even be desirable for the sheet to have a “crisp” character, i.e. to be brittle, friable, and/or adapted to be broken via one or more short, sharp fractures, in a manner akin to a potato chip or nori sheet. These embodiments may be particularly suitable for applications in which the obtrusiveness of the means by which a flavor or gustatory sensation is delivered to the consumer is less of a concern, e.g. for products which are marketed or intended to be consumed as snacks or desserts. These embodiments may also have the advantage of providing a tactile sensation for the consumer (that is, a subjectively satisfying “crispiness” or “crunchiness”) in addition to a flavor or gustatory sensation, which may improve the products' appeal to consumers.

In some embodiments, directly consumable sheets of the present invention may also be suitable for accompanying, complementing, or topping, and optionally for delivering one or more functional materials to, a food item with which the directly consumable sheet is associated and which is intended to be consumed together with the directly consumable sheet. Applications for such directly consumable sheets include, but are not limited to, use as a topping or additive for desserts (cakes, cookies, etc.), cold food items (e.g. ice cream), hot beverages (hot chocolate, coffee, tea, etc.), cold beverages (e.g. soft drinks), sparkling beverages (e.g. seltzer, club soda, etc.), alcoholic beverages, and so on. By way of first non-limiting example, a directly consumable sheet may be configured to undergo a first transformation and release a functional material, but to maintain the structural integrity of at least one flexible or semi-rigid membrane or layer, when applied to a freshly baked (and therefore hot) cake or cookie, and subsequently to undergo a second transformation (in the form of disintegration or dissolution) and release the same or a different functional material when placed in the mouth of a consumer together with the cake or cookie. By way of second non-limiting example, a directly consumable sheet may be configured to undergo a first transformation and release a functional material, but to maintain the structural integrity of at least one flexible or semi-rigid membrane or layer, when applied to a cold food item or beverage (ice cream, soft drink, etc.), and subsequently to undergo a second transformation (in the form of disintegration or dissolution) and release the same or a different functional material when placed in the mouth of a consumer together with the food item or beverage. By way of third non-limiting example, a directly consumable sheet may be configured to undergo a first transformation and release a functional material, but to maintain the structural integrity of at least one flexible or semi-rigid membrane or layer, when applied to an alcoholic beverage (for example, by dissolution of an alcohol-soluble flavoring additive or upon agitation of the alcoholic beverage), and subsequently to undergo a second transformation (in the form of disintegration or dissolution) and release the same or a different functional material when placed in the mouth of a consumer together with the alcoholic beverage.

In some embodiments, flavoring additives present in directly consumable sheets of the invention may include chocolate or flavorings similar to chocolate, alone or in combination with other flavors. One particular benefit of chocolate-flavored directly consumable sheets may be the possibility of providing the health and nutritional benefits of chocolate without the health or nutritional drawbacks; without wishing to be bound by any particular theory, this effect may be achieved in certain embodiments by providing chocolate or similar flavoring additives in lesser amounts than may be present in candies, mints, etc. that offer a similar intensity of flavor. By way of first non-limiting example, directly consumable sheets may be provided that include minerals present in dark chocolate, e.g. iron, magnesium, zinc, etc., while also including an acceptably low content of fats and sugars and/or an acceptably small per-serving calorie content. By way of second non-limiting example, directly consumable sheets may be provided that include antioxidants present in dark chocolate, e.g. flavonoids, while also including an acceptably low content of fats and sugars and/or an acceptably small per-serving calorie content. By way of third non-limiting example, directly consumable sheets may be provided that include flavanols present in dark chocolate (which stimulate nitric oxide production in the body, in turn causing vasodilation and thus improved blood flow and reduced blood pressure), while also including an acceptably low content of fats and sugars and/or an acceptably small per-serving calorie content. By way of fourth non-limiting example, directly consumable sheets may be provided that include certain compounds present in dark chocolate, e.g. polyphenols and theobromine, that may lower levels of low-density lipoprotein (“bad” cholesterol) and/or increase levels of high-density lipoprotein (“good” cholesterol), while also including an acceptably low content of fats and sugars and/or an acceptably small per-serving calorie content. By way of fifth non-limiting example, directly consumable sheets may be provided that include anti-inflammatory compounds present in dark chocolate, while also including an acceptably low content of fats and sugars and/or an acceptably small per-serving calorie content. By way of sixth non-limiting example, directly consumable sheets may be provided that provide the fasting glucose-lowering and insulin resistance-reducing effects of dark chocolate, while also including an acceptably low content of fats and sugars and/or an acceptably small per-serving calorie content. By way of seventh non-limiting example, directly consumable sheets may be provided that provide the improved brain function and neuroplasticity and increased resistance to neurodegenerative conditions characteristic of dark chocolate, while also including an acceptably low content of fats and sugars and/or an acceptably small per-serving calorie content.

In some embodiments, chocolate and/or similar ingredients (e.g. cacao, cocoa) may be present in amounts of at least about 1 wt %, at least about 2 wt %, at least about 3 wt %, at least about 4 wt %, at least about 5 wt %, at least about 10 wt %, at least about 15 wt %, at least about 20 wt %, at least about 25 wt %, at least about 30 wt %, at least about 35 wt %, at least about 40 wt %, at least about 45 wt %, at least about 50 wt %, at least about 55 wt %, at least about 60 wt %, at least about 65 wt %, at least about 70 wt %, at least about 75 wt %, at least about 80 wt %, at least about 85 wt %, at least about 90 wt %, at least about 95 wt %, at least about 96 wt %, at least about 97 wt %, at least about 98 wt %, or at least about 99 wt % of the edible sheet. In some embodiments, chocolate and/or similar ingredients (e.g. cacao, cocoa) may be present in amounts of no more than about 99 wt %, no more than about 98 wt %, no more than about 97 wt %, no more than about 96 wt %, no more than about 95 wt %, no more than about 90 wt %, no more than about 85 wt %, no more than about 80 wt %, no more than about 75 wt %, no more than about 70 wt %, no more than about 65 wt %, no more than about 60 wt %, no more than about 55 wt %, no more than about 50 wt %, no more than about 45 wt %, no more than about 40 wt %, no more than about 35 wt %, no more than about 30 wt %, no more than about 25 wt %, no more than about 20 wt %, no more than about 15 wt %, no more than about 10 wt %, no more than about 5 wt %, no more than about 4 wt %, no more than about 3 wt %, no more than about 2 wt %, or no more than about 1 wt % of the edible sheet. In some embodiments, chocolate and/or similar ingredients (e.g. cacao, cocoa) may be present in amounts from about any whole number of weight percent between about 1 wt % and about 99 wt % to any other whole number of weight percent between about 1 wt % and about 99 wt %.

In some embodiments, directly consumable sheets of the invention may have a volumetric food energy density of no more than about 5.5 dietary calories per cubic centimeter (Cal/cc), no more than about 5.0 Cal/cc, no more than about 4.5 Cal/cc, no more than about 4.0 Cal/cc, no more than about 3.5 Cal/cc, no more than about 3.0 Cal/cc, no more than about 2.5 Cal/cc, no more than about 2.0 Cal/cc, no more than about 1.9 Cal/cc, no more than about 1.8 Cal/cc, no more than about 1.7 Cal/cc, no more than about 1.6 Cal/cc, or no more than about 1.5 Cal/cc. In some embodiments, directly consumable sheets of the invention may have an areal food energy density (i.e. a food energy content per unit of surface area) of no more than about 1,400 dietary calories per square centimeter (Cal/cm²), no more than about 1,350 Cal/cm², no more than about 1,300 Cal/cm², no more than about 1,200 Cal/cm², no more than about 1,150 Cal/cm², no more than about 1,100 Cal/cm², no more than about 1,050 Cal/cm², no more than about 1,000 Cal/cm², no more than about 950 Cal/cm², no more than about 900 Cal/cm², no more than about 850 Cal/cm², no more than about 800 Cal/cm², no more than about 750 Cal/cm², no more than about 700 Cal/cm², no more than about 650 Cal/cm², no more than about 600 Cal/cm², no more than about 550 Cal/cm², no more than about 500 Cal/cm², no more than about 450 Cal/cm², or no more than about 400 Cal/cm².

Flavoring additives suitable for use in directly consumable sheets of the invention include artificial flavors (e.g. synthetic flavor oils and flavoring aromatics), natural flavors (e.g. oils, oleoresins, and extracts derived from plants, leaves, flowers, fruits, and so on), and combinations and mixtures thereof. Representative flavor oils include spearmint oil, cinnamon oil, peppermint oil, clove oil, bay oil, thyme oil, cedar leaf oil, oil of nutmeg, oil of sage, and oil of bitter almonds. Also useful are artificial, natural, or synthetic flavors such as citrus oils (e.g. oils of lemon, orange, grape, lime, grapefruit, etc.), essences of non-citrus fruits (e.g. apple, pear, peach, strawberry, raspberry, cherry, plum, pineapple, apricot, etc.), and other similar flavorings (e.g. vanilla, chocolate, coffee, cocoa, etc.). These flavorings can be used individually or in admixture. Commonly used flavors also include mints such as peppermint, artificial vanilla, cinnamon derivatives, and various fruit flavors, whether employed individually or in admixture. Flavorings such as aldehydes and esters including cinnamyl acetate, cinnamaldehyde, citral, diethylacetal, dihydrocarvyl acetate, eugenyl formate, p-methylanisole, etc. may also be used. Generally, any flavoring or food additive may be used. Further examples of aldehyde flavorings include, but are not necessarily limited to, acetaldehyde (apple); benzaldehyde (cherry, almond); cinnamic aldehyde (cinnamon); geranial or citral A (lemon, lime); neral or citral B (lemon, lime); decanal (orange, lemon); ethyl vanillin (vanilla, cream); piperonal (vanilla, cream); vanillin (vanilla, cream); alpha-amyl cinnamaldehyde (spicy fruity flavors); butyraldehyde (butter, cheese); valeraldehyde (butter, cheese); citronellal (lemon); decanal (citrus fruits); octanal (citrus fruits); nonanal (citrus fruits); dodecanal (citrus fruits); 2-ethyl butyraldehyde (berry fruits); trans-2-hexenal (berry fruits); tolyl aldehyde (cherry, almond); veratraldehyde (vanilla); 2,6-dimethyl-5-heptenal (melon); 2-6-dimethyloctanal (green fruit); 2-dodecenal (citrus, mandarin); other aldehydes that may impart similar flavors, such as cherry and/or grape; and combinations and mixtures of any of the above.

In some embodiments, the one or more flavoring additives may include a sweetener. Suitable sweeteners include those that are well-known in the art, including both natural and artificial sweeteners, such as water-soluble sweetening agents such as monosaccharides, disaccharides, and polysaccharides such as xylose, ribose, glucose (dextrose), mannose, galactose, fructose (levulose), sucrose (sugar), maltose, invert sugar (a mixture of fructose and glucose derived from sucrose), natural sweet flavors (e.g. monk fruit, coconut sugars, etc.) partially hydrolyzed starch, corn syrup solids, dihydrochalcones, monellin, steviosides, and glycyrrhizin; water-soluble artificial sweeteners such as the soluble saccharin salts, i.e. sodium or calcium saccharin salts, cyclamate salts, the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (acesulfame-K), the free acid form of saccharin, and the like; dipeptide based sweeteners, such as L-aspartic acid derived sweeteners, such as L-aspartyl-L-phenylalanine methyl ester (aspartame), L-alpha-aspartyl-N-(2,2,4,4-tetramethyl-3-thietanyl)-D-alaninamide hydrate, methyl esters of L-aspartyl-L-phenylglycerin and L-aspartyl-L-2,5, dihydrophenyl-glycine, L-aspartyl-2,5-dihydro-L-phenylalanine, L-aspartyl-L-(1-cyclohexyen)-alanine, and the like; water-soluble sweeteners derived from naturally occurring water-soluble sweeteners, such as a chlorinated derivative of ordinary sugar (sucrose); and protein-based sweeteners such as thaumatin. Effective amounts of sweetener provided in directly consumable sheets of the invention will vary with the sweetener selected, but such amount will most typically be from about 0.01 to about 10 wt %, from about 2 to about 5 wt %, from about 2 to about 8 wt %, or from about 3 to about 6 wt % of the directly consumable sheet.

In embodiments of the present invention, it may be possible to provide directly consumable sheets in which the one or more flavoring additives (chocolate, herbs, spices, etc.) are provided as a relatively large fraction of the total weight of the sheet, but the total amount of flavoring additives used is lower than would ordinarily be required in a gum, mint, candy, etc. to provide a similar intensity of flavor or gustatory sensation. In addition, the one or more flavoring additives may, but need not, be provided in varied particle sizes and/or various particle states (e.g. one or more of finely ground particles, coarsely ground particles, bits, chunks, solids, liquids, etc.). Without wishing to be bound by any particular theory, it is believed that in some embodiments, one or more flexible layers of the directly consumable sheet may, prior to or during disintegration or dissolution, adhere to or coat one or more taste-sensitive surfaces of the consumer's mouth, thereby ensuring coverage of the flavoring additive(s) over a large portion of these taste-sensitive surfaces to provide a perceived flavor or gustatory sensation that is sustained and/or increased in intensity.

The amounts of flavoring additives used in directly consumable sheets can vary so long as they are present in amounts sufficient to be perceived by a consumer upon placement of the sheet in the consumer's mouth, but not so great as to cause sticking or other processing problems. These amounts may be a matter of preference subject to such factors as flavor type, individual flavor, and the desired intensity of the perceived flavor or gustatory sensation; thus, the amounts may be varied to obtain the result desired in the final product, and these amounts are within the capabilities of those skilled in the art without undue experimentation. In general, the one or more flavoring additives may be present in directly consumable sheets in any amount from about 0.1 to about 99.9 wt %, or in any range from any tenth of a weight percent between 0.1 wt % and 99.9 wt % to any other tenth of a weight percent between 0.1 wt % and 99.9 wt %; in some embodiments, the one or more flavoring additives may be present in directly consumable sheets in an amount of at least about 50 wt %, at least about 75 wt %, or at least about 90 wt %.

In embodiments, the one or more flavoring additives in directly consumable sheets of the invention may include one or more hydrophobic liquids, e.g. an essential oil. A difficulty in formulating disintegrating or dissolving sheets incorporating these liquids in sufficient quantities to be perceptible to the consumer is that these sheets may, if not carefully formulated, be too moist and therefore difficult to handle or process. The present invention, in some embodiments, overcomes this difficulty by providing directly consumable sheets that are moist enough so as not to be brittle, but not so moist as to be perceived by the consumer as “slimy” or to adhere to other such sheets. Additionally or alternatively, directly consumable sheets may be provided with a texture on one or more surfaces that causes that sheet to “slip” relative to another sheet when stored. Thus, non-self-adhering sheets can be provided, and can be stored in contact with other such sheets (e.g. in a stack), or can be would about itself (e.g. around a spool), without the need to place a non-stick agent (e.g. a plastic film, paper, or other substrate or support) between adjacent sheets.

In some embodiments, certain additives or manufacturing steps may be employed in preparing directly consumable sheets of the present invention that may foster the incorporation of bubbles of air or other gas into the one or more flexible or semi-rigid membranes or layers of the sheet. By way of first non-limiting example, air may be injected by any suitable means directly into the base material during manufacture of the directly consumable sheet. By way of second non-limiting example, during manufacture of the directly consumable sheet, a mixture of one or more edible film-forming polymers and one or more functional materials may be whipped, rapidly stirred, or otherwise aerated. Incorporation of air or other gases may have any one or more of several benefits, including by way of non-limiting example altering the look and feel of the directly consumable sheet such that it appears less “plasticky” (e.g. having a more “natural” appearance and texture) and/or providing a tactile sensation or food texture, such as crunchiness, when consumed by a consumer.

Typically, the material(s) from which the flexible or semi-rigid membranes or layers of directly consumable sheets are made will most suitably be an edible film-forming polymer, or a combination of two or more edible film-forming polymers, due to their safety for use in ingestible products, convenience, relatively low cost, and ease of manufacturing edible sheets by various well-known methods (coating, extrusion, casting, sputtering, printing, etc.). Even more specifically, it may in some embodiments be desirable to select one or more water-soluble film-forming edible polymers, such as a water-soluble polysaccharide, as a material from which to construct the flexible or semi-rigid membranes or layers; as human mouths contain a significant quantity of moisture, the use of water-soluble polymers may improve the extent to which the edible film dissolves or disintegrates after being placed in a consumer's mouth, which may be desirable in many applications. Examples of water-soluble film-forming polymers suitable for use in the flexible or semi-rigid membranes or layers of edible sheets of the present invention include, but are not limited to, pullulan, hydroxypropyl methylcellulose (hypromellose or HPMC), carboxymethyl cellulose (CMC), hydroxypropyl cellulose (HPC), starch, gum arabic, and hydrocolloids (e.g. alginate, pectin, carrageenan, and the like). In some embodiments, one or more film-forming edible polymers that are insoluble in water (e.g. protein-based insoluble polymers, such as collagen) or soluble in water only under select conditions (e.g. protein-based polymers whose solubility in water is highly temperature-dependent, such as gelatin) may be provided instead of, or in addition to, the one or more water-soluble film-forming edible polymers to provide an additional or alternative mechanism for the breakdown or transformation of at least a portion of the edible sheet; by way of non-limiting example, collagen may be provided as part of the edible sheet to provide a thermally-induced transformation mechanism, as collagen may melt more readily than the functional material(s) (and, in some embodiments, other edible film-forming polymers) provided in the edible sheet. In summary, non-limiting examples of edible film-forming polymers suitable for use in directly consumable sheets of the invention include pullulan, hydroxypropylmethyl cellulose, hydroxyethyl cellulose, hydroxypropyl cellulose, polyvinyl pyrrolidone, carboxymethyl cellulose, polyvinyl alcohol, sodium alginate, polyethylene glycol, xanthan gum, tragacanth gum, guar gum, acacia gum, arabic gum, polyacrylic acid, methylmethacrylate copolymer, carboxyvinyl polymer, amylose, high amylose starch, hydroxypropylated high amylose starch, dextrin, pectin, chitin, chitosan, levan, elsinan, collagen, gelatin, zein, gluten, soy protein isolate, whey protein isolate, casein, and mixtures thereof. The edible film-forming polymer(s) may be present in directly consumable sheets in amounts ranging from about 0.01 to about 99 wt %, preferably about 30 to about 80 wt %, more preferably from about 45 to about 70 wt %, and even more preferably from about 60 to about 65 wt %.

In addition to one or more flavoring additives and one or more edible film-forming polymers, directly consumable sheets of the invention can further comprise one or more additional components. Non-limiting examples of such additional components include water, antimicrobial agents, film-forming agents, plasticizing agents, surfactants, stabilizing agents, emulsifying agents, thickening agents, binding agents, coloring agents, fragrances, and the like. It may in some embodiments be preferable to avoid providing large amounts of humectants in the sheet, which can result in an overly moist, self-adhering sheet.

A non-limiting example of plasticizing agents suitable for use in directly consumable sheets of the invention is triacetin, which may be present in any amount ranging from about 0 to about 20 wt %, preferably about 0 to about 2 wt %, of the sheet. Other suitable plasticizing agents include monoacetin and diacetin.

Non-limiting examples of surfactants suitable for use in directly consumable sheets of the invention include mono- and diglycerides of fatty acids and polyoxyethylene sorbitol esters, such as Atmos 300 and Polysorbate 80. The surfactant may be present in any amount ranging from about 0.5 to about 15 wt %, preferably about 1 to about 5 wt %, of the sheet. Other suitable surfactants include pluronic acid, sodium lauryl sulfate, and the like.

Non-limiting examples of stabilizing agents suitable for use in directly consumable sheets of the invention include xanthan gum, locust bean gum, and carrageenan, which may be present in any amount ranging from about 0 to about 10 wt %, preferably about 0.1 to about 2 wt %, of the sheet. Other suitable stabilizing agents include guar gum and the like.

Non-limiting examples of emulsifying agents suitable for use in directly consumable sheets of the invention include triethanolamine stearate, quaternary ammonium compounds, acacia, gelatin, lecithin, bentonite, veegum, and the like, which may be present in any amount ranging from about 0 to about 5 wt %, preferably about 0.01 to about 0.7 wt %, of the sheet.

Non-limiting examples of thickening agents suitable for use in directly consumable sheets of the invention include methylcellulose, carboxyl methylcellulose, and the like, which may be present in any amount ranging from about 0 to about 20 wt %, preferably about 0.01 to about 5 wt %, of the sheet.

A non-limiting example of binding agents suitable for use in directly consumable sheets of the invention is starch, which may be present in any amount ranging from about 0 to about 10 wt %, preferably about 0.01 to about 2 wt %, of the sheet.

Non-limiting examples of coloring agents or colorants suitable for use in directly consumable sheets of the invention include pigments such as titanium dioxide, which may be present in any amount of up to about 5 wt %, preferably from about 0.01 wt % to about 1 wt %, of the sheet; natural food colors and dyes suitable for food applications (e.g. FD&C dyes and lakes), preferably water-soluble food colors and dyes such as FD&C Blue No. 2 (the disodium salt of 5,5-indigotindisulfonic acid), Green No. 3 (the monosodium salt of 4-[4-N-ethyl-p-sulfobenzylamino) diphenyl-methylene]-[1-N-ethyl-N-p-sulfonium benzyl)-2,5-cyclo-hexadienimine]), etc.; and the like.

### Methods of Manufacture

Methods for preparing edible sheets according to the present invention are capable of capturing the functional material(s) within a film-forming matrix and maintaining the integrity of the sheet, even when the film contains hydrophobic functional material(s) in large amounts of 10 wt % or more.

In certain methods for preparing edible sheets according to the invention, film-forming ingredients may be mixed and hydrated with water separately from water-soluble ingredients, which may be mixed in aqueous solution separately from organic ingredients and surfactants. In these methods, the final formulation may be produced by mixing the film-forming phase with the aqueous phase, then mixing in the organic phase, which includes surfactants, such as Polysorbate 80 and/or Atmos 300. This mixture is mixed until emulsified. In other embodiments, aqueous and film-forming phases may be combined into a single phase by dissolving water-soluble ingredients in water and then adding gums to hydrate. The organic phase may then be added to this single aqueous phase.

The resulting formulation may be cast on a suitable substrate and dried to form a film. The film may be air-dried, for example under room-temperature or warmed air, and cut to a desired dimension, packaged, and stored. The film can contain up to about 50 wt % moisture, preferably from about 0.1 to about 10 wt % moisture, more preferably from about 3 to about 8 wt % moisture, and even more preferably from about 4 to about 7 wt % moisture.

The film-forming phase can, but need not, include a film-forming polymer and stabilizing agents such as xanthan gum, locust bean gum, and the like. These ingredients may be mixed and then hydrated in water to form a gel. The water may be heated to promote hydration. The resulting hydrated gel may then be chilled to promote formation of the edible sheet material. The water may be deionized, distilled, or otherwise purified. The aqueous phase can include ingredients such as coloring agent(s) and hydrophilic or water-soluble flavoring ingredients, e.g. sweeteners, or other functional material(s).

In certain methods of producing edible sheets according to the invention, it may be possible to hydrate film-forming ingredients and combine all of the ingredients without heating. These methods may comprise dissolving water-soluble ingredients in water to form an aqueous mixture; mixing film-forming ingredients in powder form to form a powder mixture; adding the powder mixture to the aqueous mixture to form a hydrated polymer gel; stirring the hydrated polymer gel at room temperature; adding a functional material, or a mixture of one or more functional materials, to the hydrated polymer gel and mixing until uniform; de-aerating this mixture; casting the uniform mixture on a suitable substrate; and drying the cast mixture to form a film.

In some embodiments of the methods of manufacture of the invention, the film-forming ingredients may be hydrated without heating the water. Heating the ingredients increases energy costs in the manufacturing process. Moreover, heating can in undesirable losses of volatile ingredients to evaporation.

While the preceding description has described methods of manufacture that comprise casting and drying liquid aqueous mixtures, it is to be expressly understood that edible sheets of the present invention may be suitably made by any of a number of methods known to those of ordinary skill in the art, including but not necessarily limited to coating methods (e.g. slot die, casting, knife over roll coating, etc.), extrusion methods, sputtering, printing (e.g. additive manufacturing, 3D printing), and so on.

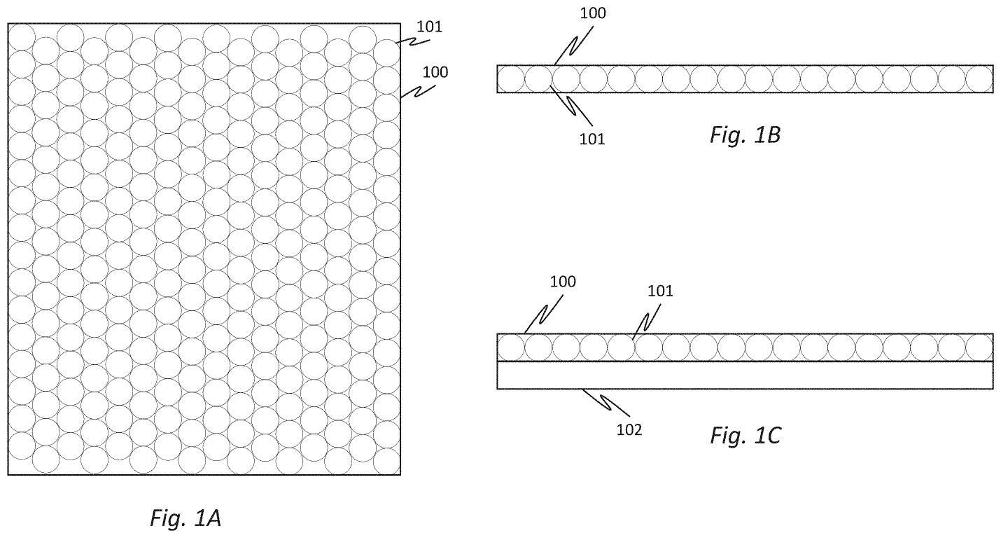

Referring now to FIG. 1A, an edible sheet 100 according to an embodiment of the present invention includes one or more food-safe functional materials, e.g. a lubricant, flavoring additive, or combination thereof, dispersed throughout one or more flexible or semi-rigid membranes or layers. In the embodiment illustrated in FIG. 1A, one or more particles 101 of the functional material(s) are dispersed throughout a flexible or semi-rigid membrane or layer that serves as a dispersion matrix or medium. Each particle 101 of functional material may be in solid, liquid, or gas form, and may (but need not) be surrounded by, encapsulated by, or contained within a discrete capsule made of the same material, and/or a different material, relative to the flexible or semi-rigid membrane or layer. In such embodiments, the discrete capsule, which may but need not be a microscale or nanoscale capsule, may itself be configured to undergo a transformation, under the same conditions as or different conditions from the conditions under which the base material is configured to undergo its transformation(s) and by the same or a different mechanism, to release the functional material(s); embodiments of this kind may allow, by way of non-limiting example, for the delivery of different “waves” or “accents” of different flavoring additives at various times after the edible sheet is placed on a food item or in a consumer's mouth. Each particle 101 or capsule may include only a single functional material, e.g. only a lubricant, or may include a combination or mixture of functional materials, e.g. both a lubricant and a flavoring additive. It is to be expressly understood that the edible sheet 100 may be constructed to have a predetermined number of particles 101 of functional material per unit surface area or volume (e.g. 400 particles per square meter of surface area, 30,000 particles per cubic meter, etc.), and/or to have a predetermined concentration of the functional material(s) by weight (which may in embodiments be between about 1 wt % and about 80 wt % of the total weight of the edible sheet 100, or alternatively in any range from any whole number percentage to any other whole number percentage between 1 wt % and 80 wt % of the total weight of the edible sheet 100). In some embodiments, different functional material(s) may be non-uniformly, preferentially, and/or selectively dispersed throughout the edible sheet 100, such that upon transformation of the edible sheet 100, different functions are imparted to different areas or regions of the cooking surface, food item, and/or mouth of the consumer to which the edible sheet 100 is applied. Where two or more functional materials are incorporated into an edible sheet 100, the relative amounts and proportions of the functional materials can be adjusted to accommodate baking needs and temperatures, material diffusivities, a desired flavor profile, and other requirements; in other words, specific examples or embodiments as disclosed herein should not be construed as limited to a particular ratio or proportion of functional materials.

Referring now to FIG. 1B, the particles 101 of functional material may be dispersed in a substantially planar distribution throughout the edible sheet 100, or in other words may all be disposed or “lie flat” in substantially the same horizontal plane. In embodiments in which the particles 101 are surrounded by, encapsulated by, or contained within a discrete capsule, the capsule may be constructed entirely of edible materials, e.g. vegetable materials, starches, etc. The discrete capsules may be configured to undergo the same or a different transformation as the flexible or semi-rigid membrane(s) or layer(s) of the edible sheet 100; for example, the capsules may be configured to break, melt, dissolve, disintegrate, etc. at a preselected temperature or moisture content (or any other preselected condition as described herein) to release the functional materials from the edible sheet 100.

While FIGS. 1A and 1B illustrates the particles 101 as being substantially uniform in size, it is to be expressly understood that the particles 101 may, in some embodiments, vary in size, and that the edible sheet 100 may be engineered or configured to have particles 101 of varying sizes. By way of non-limiting example, an edible sheet 100 may comprise particles 101 of two or more different functional materials, such that the particles 101 of one functional material are generally smaller or larger than the particles 101 of another functional material. By way of further non-limiting example, particles 101 of a single functional material may be provided in a range or distribution of sizes within the edible sheet 100 to provide for, e.g., a controlled release of the functional material (wherein smaller particles 101 are released more quickly and larger particles 101 are released more slowly, or vice versa), a multifunctional release of the functional material (wherein smaller particles 101 are released upon satisfaction of a first condition and larger particles 101 are released upon satisfaction of a different condition), and the like.

Referring now to FIG. 1C, an edible sheet 100 may comprise an edible or inedible substrate or carrier layer 102. For example, an edible sheet 100 may comprise a thin layer of one or more of a fiber, a starch, a gelatin, an agar, a grain, a rice, a fruit, and/or a vegetable. This thin layer may be placed on an edible or inedible substrate or carrier layer 102 such as a paper layer, a plastic layer, a wax paper layer, a silicone-coated paper layer, or another layer comprising one or more of a starch, a gelatin, an agar, a grain, a rice, a fruit, and/or a vegetable. The substrate or carrier layer 102 may be used for packaging and/or handling the edible sheet 100. In some embodiments, the substrate or carrier layer 102 may be removed by a user prior to using the edible sheet 100 in the preparation of food and/or prior to placing the edible sheet in his or her mouth. In some embodiments, the substrate or carrier layer 102 may be optional. In some embodiments, the substrate or carrier layer 102 may itself be configured to undergo a transformation upon satisfaction of the same or different conditions needed to trigger a transformation in the other layers of the edible sheet 100, e.g. the substrate or carrier layer 102 may be configured to dissolve or disintegrate upon exposure to heat and/or moisture.

The flexibility of the flexible or semi-rigid membrane(s) or layer(s) of edible sheets 100 according to the present invention, such as those illustrated in FIGS. 1A through 1C, may vary depending on the selected functional material(s) and intended applications or uses of the edible sheet 100. In some embodiments, it may be desirable to provide a membrane or layer having a very high degree of flexibility akin to printing paper or tissue paper, allowing the edible sheet 100 (or one or more selected membranes or layers thereof) to be easily folded, torn, etc., whereas in other embodiments it may be desirable to provide a less flexible and/or more rigid membrane or layer having a flexibility akin to cover stock, card stock, paperboard, or corrugated fiberboard. In some embodiments, it may even be desirable for the sheet to have a “crisp” character, i.e. to be brittle, friable, and/or adapted to be broken via one or more short, sharp fractures, in a manner akin to a potato chip or nori sheet, and such embodiments are within the scope of the invention. Those of ordinary skill in the art will appreciate how to select an appropriate flexibility for each layer of the edible sheet 100, based on the specific nature and characteristics of an application or use.

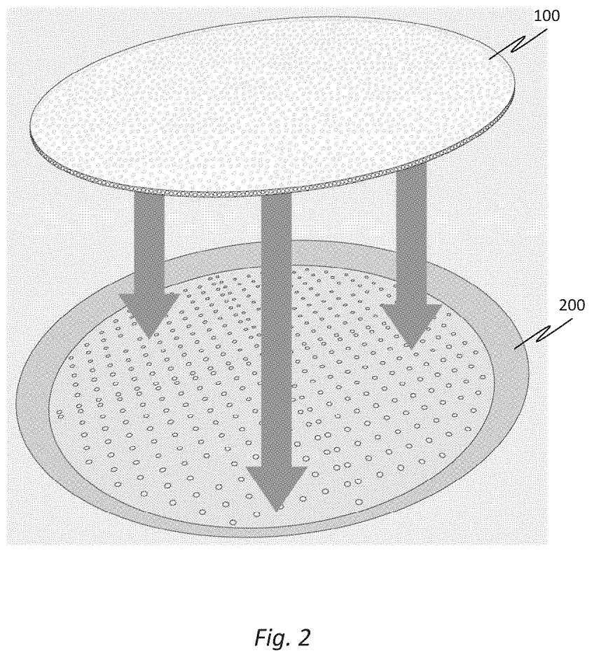

Referring now to FIG. 2, the edible sheet 100 may be provided in a circular, elliptical, or other rounded shape that substantially conforms to or matches a cooking surface, such as a pizza pan 200. In some embodiments, the edible sheet 100 may be pre-formed to a particular size and shape, or may be configured to be cut or torn to the desired size and shape prior to or as part of the food preparation process and/or prior to or as part of the process by which a consumer places the edible sheet 100 in his or her mouth. In further embodiments, the edible sheet 100 may be provided in a narrow-strip roll, which may allow a user to dispense and/or cut the edible sheet 100 to a desired length to accommodate any of a wide range of applications (e.g. different sizes and/or shapes of food items, different sizes of consumer mouths, different amounts of flavor or intensities of gustatory sensation desired by the consumer, etc.).

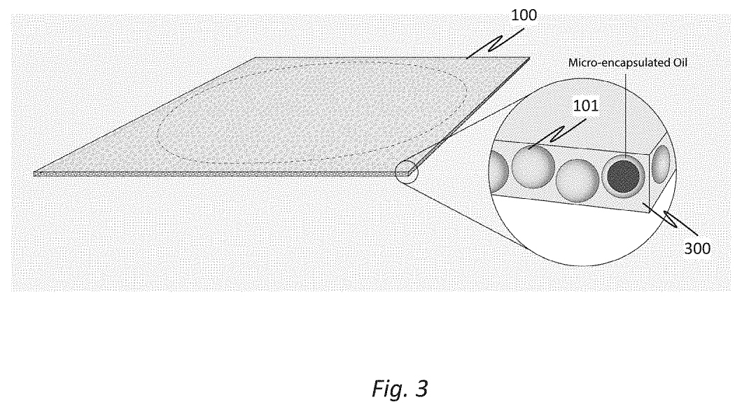

Referring now to FIG. 3, another possible configuration of the edible sheet 100 is illustrated, whereby the edible sheet 100 has a non-circular or non-rounded shape, e.g. a rectangular shape, but is sufficiently sized to receive a round or circular food item, e.g. a pizza, a cookie, etc. FIG. 3 further illustrates additional details of the edible sheet 100; specifically, in this embodiment, the edible sheet 100 may include particles 101 of functional material as described above suspended within a base material 300, which may provide a desired structure to support or disperse the particles 101. The material(s) used for the base material 300 may be the same as or different from the material(s) used for the flexible or semi-rigid membrane(s) or layer(s) of the edible sheet 100 and/or, if provided, the discrete capsules that surround, enclose, and/or encapsulate the functional material particles 101; by way of non-limiting example, the base material 300 may comprise one or more of a gelatin, a starch, an agar, a grain, a rice, a fruit, and/or a vegetable. The base material 300 may be configured to undergo the same or a different transformation as the flexible or semi-rigid membrane(s) or layer(s) of the edible sheet 100; for example, the base material 300 may be configured to break, melt, dissolve, disintegrate, etc. at a preselected temperature or moisture content (or any other preselected condition as described herein) to release the functional materials from the edible sheet 100.

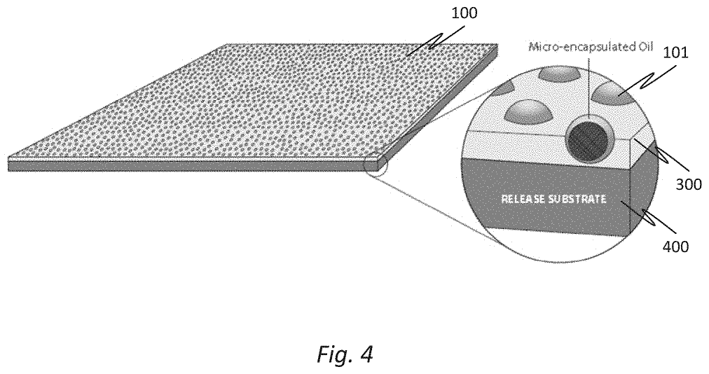

Referring now to FIG. 4, a further enhancement of an edible sheet 100 may be provided in the form of a release substrate or film 400 that further supports the base material 300. In some embodiments, the base material 300 may contain the functional material particles 101 and both the base material 300 and the particles 101 may be supported by the release substrate or film 400. In some embodiments, the release substrate or film 400 may be or comprise a known substrate or film used in food preparation, such as wax paper or the like.

FIG. 4 further illustrates the possibility of at least a portion of a particle 101 of functional material, whether or not surrounded by, enclosed by, or encapsulated by a discrete capsule, protruding above, beyond, or outside of the base material 300. In some embodiments, a portion of at least one particle 101 may be surrounded and therefore supported by the base material 300; however, another portion of one or more particles 101 may be exposed above, beyond, or outside of the base material 300, and in some cases above, beyond, or outside of the flexible or semi-rigid membrane(s) or layer(s) of the edible sheet 100. In this way, some or all of the contents of some particles 101 may be released before the entirety of an associated membrane or layer of the edible sheet 100 has undergone a transformation; such functionality may be desirable, by way of non-limiting example, where the edible sheet 100 is specifically intended to provide varying degrees of texture or crunchiness to an outer food surface by precisely controlling the total amount of oil or other texturizing agent transferred to the outer food surface. This control over the edible sheet 100 ultimately enables greater control over the properties of the completed food item. Thus, in some embodiments, the proportion of the surface of a particle 101 that is exposed beyond the base material 300 may control the rate at which and/or extent to which the functional material(s) is/are released from the edible sheet 100, which may enable an incremental and/or controlled-release edible sheet 100. Similarly, modifying the depth to which particles 101 are dispersed within the base material 300 may enable any of a number of substantially different effects on the food item during cooking, baking, or the like.

Additionally or alternatively, an edible sheet 100 can be specifically designed, engineered, and/or manufactured to provide a desired release rate of the functional material(s) (lubricant, flavoring additive, etc.) by controlling parameters such as carrier and/or base composition, thickness of the edible sheet 100 as a whole and/or individual membranes or layers thereof, conditions to be satisfied to trigger transformation of the edible sheet 100 (temperature, moisture content, etc.), and so on. By comparison, pouring, spraying, and/or rubbing lubricants and flavoring additives provides very poor control over the amount of functional material applied and no control over release rate, which can contribute to inconsistent food quality and limited flexibility in the food preparation process (especially in the quick-serve and fast-casual food industries where a chef or experienced cook does not oversee the food preparation process) and/or to a consumer experiencing a more or less intense gustatory sensation than desired when placing the edible sheet 100 in his or her mouth.

As illustrated in FIG. 4, edible sheets 100 according to the present invention may include particles 101 of functional material that at least partially protrude from a surface of the edible sheet 100. However, it is to be expressly understood that the spatial distribution of particles 101, and the extent to which particles 101 protrude from surfaces of and/or the depth to which particles 101 are embedded within a bulk of the edible sheet 100, may be varied to provide for, e.g., a controlled release of the functional material (wherein protruding particles 101 are released more quickly and embedded particles 101 are released more slowly, or vice versa), a multifunctional release of the functional material (wherein protruding particles 101 are released upon satisfaction of a first condition and embedded particles 101 are released upon satisfaction of a different condition), and the like.

As described herein, edible sheets according to the present invention may be useful in preparing any of a wide variety of food items. Non-limiting examples of such food items include pizzas and other savory baked items, pastries and other sweet baked items, broths or soups, meat items, beverages, and many others. In some embodiments, the food item may be adapted to cooked (by baking, frying, microwaving, roasting, sauteing, steaming, etc.) before, during, or after the transformation of the edible sheet 100, while in other embodiments the food item may be a raw or otherwise uncooked food item. In some embodiments, the same procedures used for cooking or processing the food item itself (e.g. heating the food item and/or a cooking surface associated therewith, adding water to the food item, kneading or otherwise physically manipulating the food item, etc.) may trigger the transformation in the edible sheet.

Methods of using the edible sheets as described herein may enable a user to customize a layering of flavorings and/or food textures imparted by the edible sheets. For example, a “crispy,” “crunchy,” or “crusty” texture for a food item, e.g. a meat item, may be provided by applying an appropriate edible sheet or combination of multiple edible sheets during the food preparation process. A consumer or customer could further specify one or more ingredients that he or she wishes to have “embedded” or “encrusted” into or onto a surface of a food item, and a user could construct an appropriate “composite” edible sheet by combining or stacking one or more edible sheets according to the invention to achieve the result desired by the consumer or customer. Thus, the present invention provides for a greater degree of customization of food items for a particular consumer, without slowing down the food preparation process.

Methods of using the edible sheets as described herein may also enable a consumer to customize a blend or mixture of perceived flavors imparted by flavoring ingredients of the edible sheets. For example, a “chocolatey” flavor may be provided in combination with a salty flavor, a savory (umami) flavor, etc. by the consumer's placement of an appropriate edible sheet or combination of multiple edible sheets in his or her mouth. The consumer could also construct an appropriate “composite” edible sheet by combining or stacking one or more edible sheets according to the invention to achieved the desired flavor profile and/or gustatory sensation. Thus, the present invention allows a consumer to customize a flavor profile or gustatory sensation and to unobtrusively obtain or experience the same.

It is to be expressly understood that, in some embodiments, edible sheets need not cover the entirety of a cooking surface and/or surface of a food item, and/or the entirety of any particular surface of a consumer's mouth (e.g. the surface of the tongue), to which the edible sheet is applied. Instead, the edible sheet can be disposed on any portion of such surfaces, e.g. a ring-shaped or annular edible sheet could be disposed only on an outer portion of a circumference of a pizza, and can be placed on only a top surface, only a bottom surface, or both. This feature allows different flavors and/or textures to be imparted to different areas, regions, or surfaces of a food item, such as a pizza or meat item, or to different areas, regions, or surfaces of a consumer's mouth.

A first non-limiting example of applications or uses for the edible sheets of the present invention is for the flavoring of solid foods. In such applications, the functional material(s) dispersed throughout the one or more flexible or semi-rigid membranes or layers may include a flavoring additive, such as one or more herbs or spices, and the edible sheet may be placed directly onto the surface of a solid food item to be flavored (e.g. a cooked or uncooked baked good, a cooked or uncooked cut of meat, etc.). A transformation may then be induced in the edible sheet (e.g. by applying heat or moisture, or by any other means of inducing a transformation as described herein) to cause the functional material(s) to be released from the edible sheet and transferred onto the surface of the food item to be either adsorbed onto the food item (i.e. transferred to and residing on the surface of the solid food item) or absorbed into the bulk of the solid food item (e.g. by dissolution or diffusion). In non-limiting exemplary embodiments, the edible sheet may be adapted to undergo the transformation upon being simultaneously or sequentially (in any order) exposed to both (i) a temperature of at least about 80° F., in some embodiments between about 80° F. and about 500° F., and (ii) a material having a moisture content, and/or an atmosphere having a relative humidity, of at least about 10%.

A second non-limiting example of applications or uses for the edible sheets of the present invention is for the flavoring of liquid foods. In such applications, the functional material(s) dispersed throughout the one or more flexible or semi-rigid membranes or layers may include a flavoring additive, such as one or more herbs or spices, and the edible sheet may be placed directly onto the surface, or into the bulk, of a liquid food item to be flavored (e.g. a beverage, a broth, a soup, etc.). The functional material(s) may be provided in any one or more suitable physical forms, including but not limited to finely ground solids, coarsely ground solids, liquids, oleoresins, essential oils, and so on. A transformation may then be induced in the edible sheet (e.g. by applying heat or moisture, or by any other means of inducing a transformation as described herein) to cause the functional material(s) to be released from the edible sheet and transferred onto the surface of the food item to be either adsorbed onto the food item (i.e. transferred to and residing on the surface of the solid food item) or absorbed into the bulk of the solid food item (e.g. by dissolution or diffusion). In non-limiting exemplary embodiments, the edible sheet may be adapted to undergo the transformation upon being simultaneously (i) exposed to a temperature of at least about 32° F. and (ii) wetted by, placed on a surface of, and/or exposed to or partially or fully immersed or submerged within a volume of, a liquid (e.g. water, a beverage, a broth, etc.).

A third non-limiting example of applications or uses for the edible sheets of the present invention is for the lubrication of a cooking surface. In such applications, the functional material(s) dispersed throughout the one or more flexible or semi-rigid membranes or layers may include a lubricant, such a food-safe grease or oil, and the edible sheet may be placed directly onto the cooking surface to be lubricated (e.g. a pan or tray). A transformation may then be induced in the edible sheet (e.g. by applying heat or moisture, or by any other means of inducing a transformation as described herein) to cause the functional material(s) to be released from the edible sheet and transferred onto the cooking surface to be adsorbed onto the cooking surface. In some cases, a user may, before, during, or after transformation of the edible sheet, dispose a food item (e.g. an uncooked food item intended to be cooked on the cooking surface) on a surface of the edible sheet opposite the cooking surface, such that, upon transformation of the edible sheet, the released lubricant forms a layer of lubricant between the cooking surface and the food item. In non-limiting exemplary embodiments, the edible sheet may be adapted to undergo the transformation upon being simultaneously or sequentially (in any order) exposed to both (i) a temperature of at least about 80° F., in some embodiments between about 80° F. and about 500° F., and (ii) a material having a moisture content, and/or an atmosphere having a relative humidity, of at least about 10%.

A fourth non-limiting example of applications or uses for the edible sheets of the present invention is to impart moisture to, or improve the moisture retention capabilities of, a food item. In such applications, the functional material(s) dispersed throughout the one or more flexible or semi-rigid membranes or layers may include water and/or a food-safe moisturizing agent, and the edible sheet may be placed directly onto the surface of a solid food item. A transformation may subsequently be induced in the edible sheet (e.g. by applying heat or moisture, or by any other means of inducing a transformation as described herein) to cause the functional material(s) to be released from the edible sheet and transferred onto the surface of the food item to be either adsorbed onto the food item (i.e. transferred to and residing on the surface of the solid food item) or absorbed into the bulk of the solid food item (e.g. by dissolution or diffusion).

The invention is further described by way of the following non-limiting Examples.

### Example 1

### Single-Layer Italian-Style Flavoring Sheet

An edible sheet according to the present invention comprises particles of an Italian-style flavoring additive comprising salt, oregano, basil, and a cooking oil, e.g. olive oil. The flavoring additive may be provided as separate particles of each component of the flavoring additive (i.e. separate salt particles, oregano particles, basil particles, and oil particles) and/or as particles comprising a combination of two or more components of the flavoring additive (e.g. particles comprising a combination or mixture of all components; a plurality of liquid particles comprising the oil and a separate plurality of solid particles comprising a combination or mixture of the salt, the oregano, and the basil; a plurality of liquid particles comprising a combination or mixture of the oil and an oregano oleoresin and a separate plurality of solid particles comprising a combination or mixture of the salt and the basil; etc.). The components of the flavoring additive are generally provided in sufficient quantities to yield 20 grams of salt per square meter of sheet, 2 grams of oregano per square meter of sheet, 2 grams of basil per square meter of sheet, and 4 grams of oil per square meter of sheet. The particles of Italian-style flavoring additive are substantially uniformly dispersed throughout a single flexible or semi-rigid membrane or layer of a food-safe base material.

The edible sheet may be configured to undergo a transformation to release the particles of the Italian-style flavoring additive upon the satisfaction of any one or more environmental conditions as described herein. The edible sheet of this Example is thus suitable to, for example, provide an Italian-style flavor to a food item to which the edible sheet is applied, and optionally also to lubricate a cooking surface on which the food item is intended to be cooked.

### Example 2

### Chocolate- and Bacon-Flavored Directly Consumable Sheet

A directly consumable sheet according to the present invention comprises particles of milk chocolate (e.g. having a cacao content of about 45%), vanilla (solid beans or pieces thereof and/or particles of liquid extract), maple sugar, pieces of uncured bacon (or particles of a liquid or solid flavoring additive derived therefrom), smoked sea salt, and liquid or solid particles of a naturally-derived maple flavoring additive. These flavoring additives may be provided as separate particles of each component and/or as particles comprising a combination of two or more components. The components of the flavoring additive are generally provided in sufficient quantities for each to be gustatorily perceived by a consumer quickly (e.g. within between about 1 second and about 1 minute) after the consumer places the directly consumable sheet in their mouth. The particles of flavoring additive are substantially uniformly dispersed throughout a single flexible or semi-rigid membrane or layer of a food-safe base material.

The edible sheet may be configured to undergo a transformation to release the particles of the flavoring additive upon the satisfaction of any one or more environmental conditions as described herein. The edible sheet of this Example is thus suitable to, for example, deliver chocolate and bacon flavors (i.e. a gustatory sensation of chocolate and bacon) to a consumer wishing to experience a sensation, without the drawbacks of other chocolate- and/or bacon-flavored foods described elsewhere throughout this disclosure.

The invention illustratively disclosed herein suitably may be practiced in the absence of any element which is not specifically disclosed herein. It is apparent to those skilled in the art, however, that many changes, variations, modifications, other uses, and applications of the invention are possible, and also changes, variations, modifications, other uses, and applications which do not depart from the spirit and scope of the invention are deemed to be covered by the invention, which is limited only by the claims which follow.

The foregoing discussion of the invention has been presented for purposes of illustration and description. The foregoing is not intended to limit the invention to the form or forms disclosed herein. In the foregoing Detailed Description of the Invention, for example, various features of the invention are grouped together in one or more embodiments for the purpose of streamlining the disclosure. The features of the embodiments of the invention may be combined in alternate embodiments other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description of the Invention, with each claim standing on its own as a separate preferred embodiment of the invention.

Moreover, though the description of the invention has included description of one or more embodiments and certain variations and modifications, other variations, combinations, and modifications are within the scope of the invention, e.g. as may be within the skill and knowledge of those in the art, after understanding the present disclosure. It is intended to obtain rights which include alternative embodiments to the extent permitted, including alternate, interchangeable, and/or equivalent structures, functions, ranges, or steps to those claimed, whether or not such alternate, interchangeable, and/or equivalent structures, functions, ranges, or steps are disclosed herein, and without intending to publicly dedicate any patentable subject matter.

1. A directly consumable sheet, comprising:
a flexible or semi-rigid layer, comprising a food-safe solid base material; and
a plurality of particles of a flavoring additive, dispersed throughout the base material,
wherein the directly consumable sheet is configured such that, when a predetermined condition is satisfied, at least a portion of the particles of the flavoring additive are released from the base material into a surrounding environment.

2. The directly consumable sheet of claim 1, wherein the particles of the flavoring additive are colloidally dispersed throughout the base material.

3. The directly consumable sheet of claim 2, wherein the flavoring additive is in the liquid phase and the directly consumable sheet is a gel.

4. The directly consumable sheet of claim 2, wherein the flavoring additive is in the solid phase and the directly consumable sheet is a solid sol.

5. The directly consumable sheet of claim 1, wherein the base material is an edible material that comprises at least one of a starch, a gelatin, an agar, a grain, a rice, a fruit, and a vegetable.

6. The directly consumable sheet of claim 1, wherein the base material comprises at least one edible film-forming polymer.

7. The directly consumable sheet of claim 7, wherein the at least one edible film-forming polymer is selected from the group consisting of pullulan, hydroxypropyl methylcellulose, carboxymethyl cellulose, hydroxypropyl cellulose, alginate, pectin, carrageenan, collagen, gelatin, starch, and gum arabic.

8. The directly consumable sheet of claim 1, wherein the flexible or semi-rigid layer comprises a fiber matrix formed by the base material, wherein the particles of the flavoring additive are dispersed within the fiber matrix.

9. The directly consumable sheet of claim 8, wherein the functional material is dispersed within the fiber matrix via vapor deposition.

10. The directly consumable sheet of claim 1, wherein the flexible or semi-rigid layer comprises a plurality of perforations to allow a consumer to tear the directly consumable sheet into multiple pieces having predetermined shapes.

11. The directly consumable sheet of claim 1, wherein the surrounding environment is a mouth of a consumer, wherein the predetermined condition is satisfied upon placement of the directly consumable sheet in the mouth of the consumer.

12. The directly consumable sheet of claim 11, wherein the predetermined condition comprises a temperature exceeding a predetermined threshold, wherein the predetermined threshold is at least about 25° C. and no more than about 37° C.

13. The directly consumable sheet of claim 11, wherein the predetermined condition comprises exposure to moisture within the mouth of the consumer, the base material comprises a water-soluble polymer, and the directly consumable sheet is configured to release the at least a portion of the particles due to dissolution of at least a portion of the base material in an aqueous liquid present in the mouth of the consumer.

14. The directly consumable sheet of claim 13, wherein the aqueous liquid is saliva.

15. The directly consumable sheet of claim 1, wherein the flavoring additive comprises chocolate.

16. The directly consumable sheet of claim 15, wherein the flavoring additive further comprises an herb, spice, or edible flower or portion thereof.

17. A method for providing a gustatory sensation to a consumer, comprising:
providing to the consumer a directly consumable sheet, comprising:
a flexible or semi-rigid layer, comprising a food-safe solid base material; and
a plurality of particles of a flavoring additive, dispersed throughout the base material,
wherein the directly consumable sheet is configured such that, when the consumer places the consumer in their mouth, a predetermined condition is satisfied, wherein, upon satisfaction of the predetermined condition, at least a portion of the particles of the flavoring additive are released from the base material into a surrounding environment.

18. The method of claim 17, wherein the predetermined condition comprises a temperature exceeding a predetermined threshold, wherein the predetermined threshold is at least about 25° C. and no more than about 37° C.

19. The method of claim 17, wherein the predetermined condition comprises exposure to moisture within the mouth of the consumer, the base material comprises a water-soluble polymer, and the directly consumable sheet is configured to release the at least a portion of the particles due to dissolution of at least a portion of the base material in an aqueous liquid present in the mouth of the consumer.

20. The method of claim 19, wherein the aqueous liquid is saliva.
